(19) United States
(12) Patent Application Publication
(10) Pub. No.: US 2026/0056871 A1
(43) Pub. Date: Feb. 26, 2026

(54) SOFTWARE PROGRAM TEST GENERATION FOR COMPUTING SYSTEMS AND APPLICATIONS

(71) Applicant: NVIDIA Corporation, Santa Clara, CA (US)

(72) Inventors: Maksym BAZALII, Timnath, CO (US); Thomas Michael MCREYNOLDS, Los Altos Hills, CA (US)

(21) Appl. No.: 18/812,954

(22) Filed: Aug. 22, 2024

(51) Int. Cl. G06F 11/36

(52) U.S. Cl. CPC G06F 11/3684; G06F 11/3608

(57) ABSTRACT

Embodiments of the present disclosure relate to applications, platforms, architecture, etc. for automating software requirement verification. In particular, one or more generative language model (GLM) prompts may be generated based at least on program information that describes a software program and based on requirement information that corresponds to a requirement of the software program. Based on such prompts, the GLM may be able to automatically identify segments of the software program information that relate to the requirement. Further, based on the identified segments and the GLM prompts, the GLM may be able to automatically create (e.g., based on one or more additional prompts) testing architecture that may be used to verify whether the software program satisfies the requirement.

### BACKGROUND

Testing of software programs is often a labor-intensive process. For example, a software program may have multiple different requirements related to targeted behavior of the software program. Typically, for a given a software requirement or requirement verification step, an engineer may manually look for corresponding portions of documentation of the software program (“program documentation”) that may relate to the targeted behavior. For example, the engineer may manually review corresponding software architecture documentation and/or interface specification documentation to identify segments of such documentation that correspond to the targeted behavior. After the software architecture and interface specification segments are identified, the engineer typically then reviews a list of individual requirements and corresponding requirement verification steps and creates multiple test cases for each requirement. These test cases may then be used as the baseline for integration tests or unit tests, which may be code that may be used to implement the test cases and verify whether the software program satisfies the corresponding requirement. Such a process may need to be performed with respect to each requirement, which is burdensome and requires extensive human effort.

### SUMMARY

Embodiments of the present disclosure relate to automated software program test generation. In particular, systems and methods are disclosed that automate one or more aspects of testing software programs. For example, one or more generative language model (GLM) prompts may be generated based at least on program information that describes a software program. For example, the program information may include program such as architecture documentation (also generally referred to as the “program architecture” or the “architecture” in the present disclosure) and/or interface specification documentation (also referred to as the “program interface specification” or the “interface specification” in the present disclosure). In these and other embodiments, the GLM prompts may be generated based on requirement information that describes a requirement corresponding to the software program.

Based on such prompts, the GLM may be able to automatically identify segments of the software program information that relate to the requirement—e.g., the GLM may automatically identify one or more portions of the program architecture that relate to the requirement and/or one or more portions of the program interface specification that relate to the requirement. Further, based on the identified segments and the GLM prompts, the GLM may be able to automatically create (e.g., based on one or more additional prompts) testing architecture that may be used to verify whether the software program satisfies the requirement.

For example, in some embodiments the testing architecture may include a test specification that defines behavior that may verify whether the software program satisfies the requirement. In these and other embodiments, the test specification may include one or more test cases that may indicate one or more verification steps that may be used for verifying such behavior. Additionally or alternatively, the testing architecture may include a test implementation for testing satisfaction of the requirement. The test implementation may include code or routines that may implement the test specification in the programing language of the software program. The test implementation may then be used to test the software program.

The embodiments described herein may provide a significant improvement in the field of software testing and development. In particular, the automation of the generation of testing architecture for software programs may significantly reduce the amount of time needed to test and deploy software programs. Further, the embodiments help improve the functionality of computing systems themselves by providing a specific mechanism and series of steps and operations that allow for computing systems to be able to automatically generate such testing architecture.

### BRIEF DESCRIPTION OF THE DRAWINGS

The present systems and methods for software program test generation are described in detail below with reference to the attached drawing figures, wherein:

FIG. 1 illustrates an example system related to testing software programs, according to one or more embodiments of the present disclosure;

FIG. 2 illustrates an example process that may be performed to generate a testing architecture, according to one or more embodiments of the present disclosure;

FIG. 3 illustrates an example architecture segment identification process, according to one or more embodiments of the present disclosure;

FIG. 4 illustrates an example program interface specification segment identification process, according to one or more embodiments of the present disclosure;

FIG. 5 illustrates an example test specification generation process, according to one or more embodiments of the present disclosure;

FIG. 6 illustrates an example test implementation generation process, according to one or more embodiments of the present disclosure;

FIG. 7 is a flow diagram showing a method for generating a testing architecture for a software program, according to one or more embodiments of the present disclosure;

FIG. 8A is a block diagram of an example generative language model system suitable for use in implementing at least some embodiments of the present disclosure;

FIG. 8B is a block diagram of an example implementation in which the generative LM of FIG. 8A includes a transformer encoder-decoder, according to one or more embodiments of the present disclosure;

FIG. 8C is a block diagram of an example implementation in which the generative LM of FIG. 8A includes a decoder-only transformer architecture, according to one or more embodiments of the present disclosure;

FIG. 9 is a block diagram of an example computing device suitable for use in implementing one or more embodiments of the present disclosure;

FIG. 10 is a block diagram of an example data center suitable for use in implementing one or more embodiments of the present disclosure;

FIG. 11A is an illustration of an example autonomous vehicle, in accordance with one or more embodiments of the present disclosure;

FIG. 11B is an example of camera locations and fields of view for the example autonomous vehicle of FIG. 11A, according to one or more embodiments of the present disclosure;

FIG. 11C is a block diagram of an example system architecture for the example autonomous vehicle of FIG. 11A, according to one or more embodiments of the present disclosure; and

FIG. 11D is a system diagram for communication between cloud-based server(s) and the example autonomous vehicle of FIG. 11A, according to one or more embodiments of the present disclosure.

### DETAILED DESCRIPTION

Systems and methods disclosed herein relate to automating the testing of software programs. In particular, the present disclosure relates to creating a mechanism in which generative language models (GLMs) may be used to generate testing architecture for software programs. For example, as discussed in detail in the present disclosure, one or more embodiments may be configured to generate prompts for GLMs in which the prompts are used by the GLMs to generate the testing architecture.

In some embodiments, the prompts may be generated such that a GLM is able to identify which portions of program information (e.g., program documentation that describes various aspects of the program) may relate to functionality of the software program that may correspond to a particular requirement corresponding the software program. For example, the requirement may include target functionality of the software program. Additionally or alternatively, the requirement may include target performance of the software program. In these and other embodiments, the requirement may include target behavior of the software program in response to certain inputs. Additionally or alternatively, the requirement may include certain requirements related to testing of the software program, such as requirements related to types of tests to perform.

The prompts may also be such that the GLM is able to identify, as part of the testing architecture and based on the identified portions of the program information, a test specification that may define behavior of the software program that may indicate whether the software program satisfies the requirement. In these and other embodiments, the GLM may be able to identify based on the prompts, as part of the test specification, one or more test cases that may indicate one or more operations (referred to as “verification steps” in the present disclosure) that may be performed by the software program, the results of which may help verify whether the behavior of the software program is consistent with that defined with respect to the test specification.

Additionally or alternatively, one or more embodiments of the present disclosure may relate to the GLM being used in the generation of a test implementation based on the prompts. The test implementation may be included in the testing architecture and may include code or routines that may implement the test specification in the programing language of the software program such that the execution of the test implementation with respect to the software program may be used to determine whether the software program performs the behavior defined by the test specification to determine whether the software program satisfies the requirements.

Further, the embodiments may have a broad application across various different types of testing of software programs. For example, the testing may include functionality testing that may determine whether the software programs have certain functionality, security testing that may be used to determine whether the software programs have certain vulnerabilities (including “fuzzing” in which various abnormal inputs are provided to the software programs), etc. Additionally or alternatively, other types of tests may include unit tests, performance tests, and/or integration tests.

In these and other embodiments, the systems and methods may be implemented across a variety of different platforms, such as cybersecurity environments (e.g., NVIDIA®'s LaunchPad), simulation environments (e.g., NVIDIA®'s Drive SIM®), software development kits (e.g., NVIDIA®'s DriveWorks, NVIDIA®'s Omniverse), software application toolkits (e.g., NVIDIA®'s CUDA® Toolkit), or any other suitable platform for which software may be developed.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

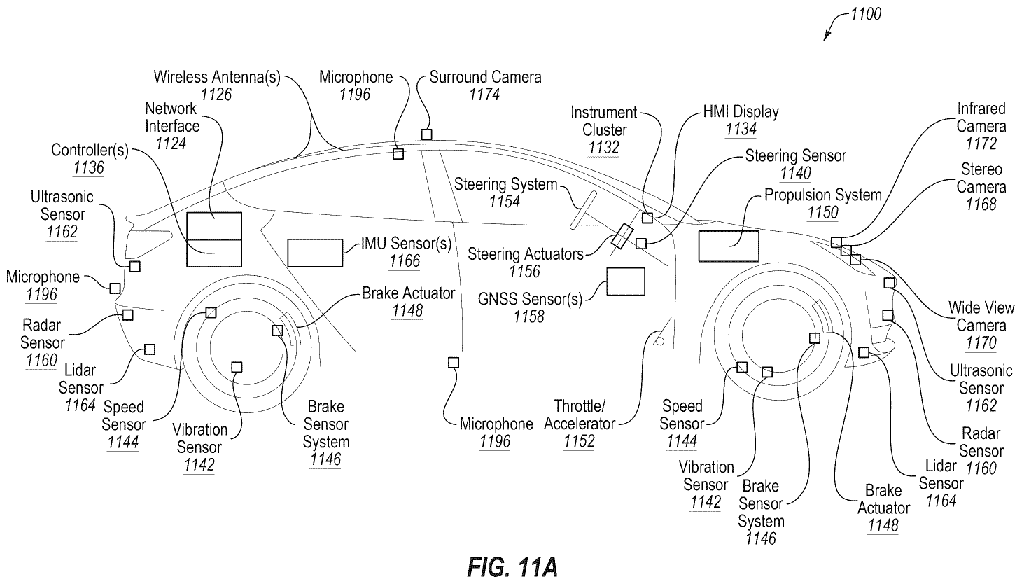

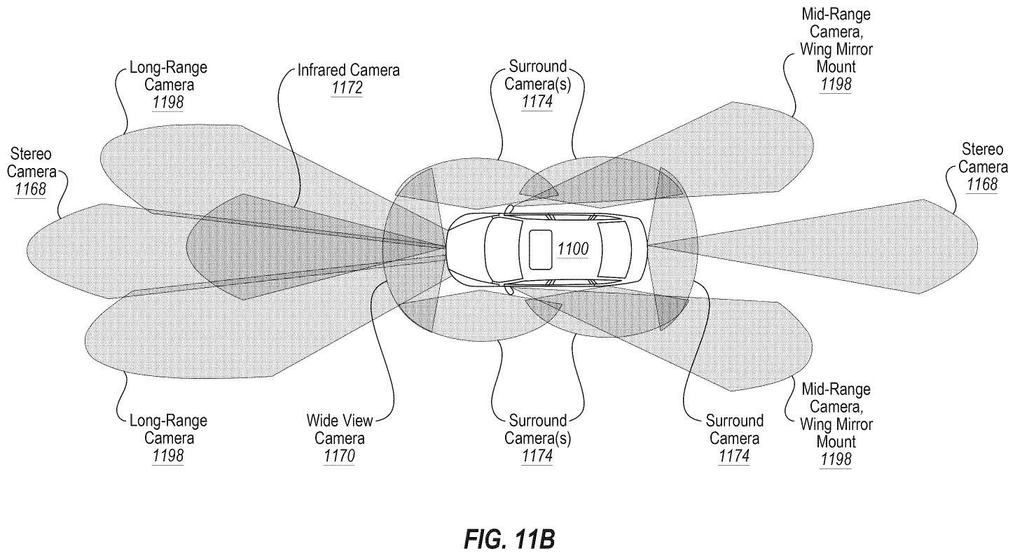

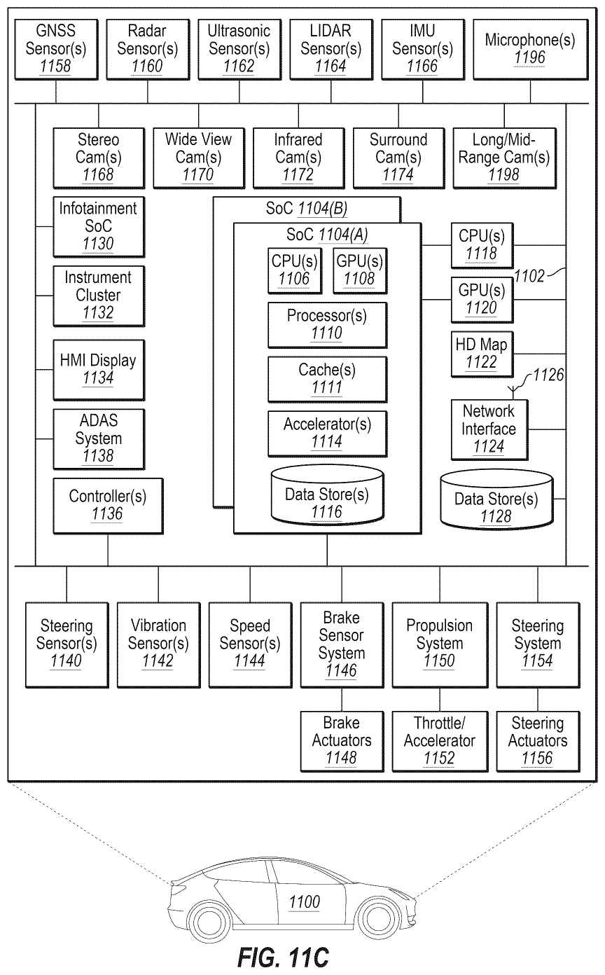

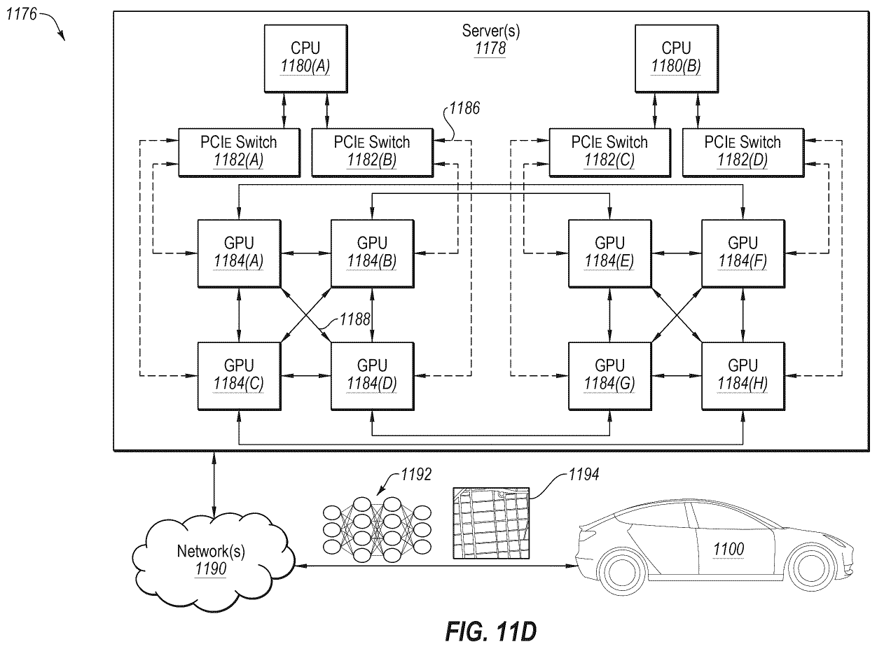

Further, one or more embodiments of the present disclosure may relate to software program testing associated with ego-machines and/or components of the one or more ego-machines, which may include any applicable machine or system that is capable of performing one or more autonomous or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous vehicle 1100 (alternatively referred to herein as “vehicle 1100” or “ego-machine 1100”) described with respect to FIGS. 11A-11D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

In some examples, the machine learning model may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model is small enough (e.g., has a small enough number of parameters), the model may be included within the container itself. In other examples—such as where the model is large—the model may be hosted/stored in the cloud (e.g., in a data center) and/or may be hosted on-premises and/or at the edge (e.g., on a local server or computing device, but outside of the container). In such embodiments, the model may be accessible via one or more APIs—such as REST APIs. As such, and in some embodiments, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

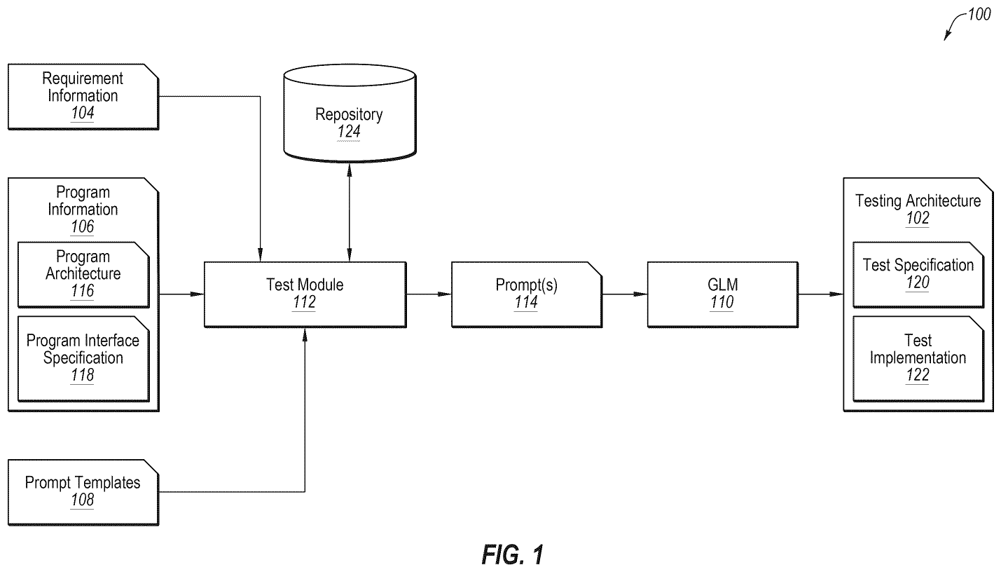

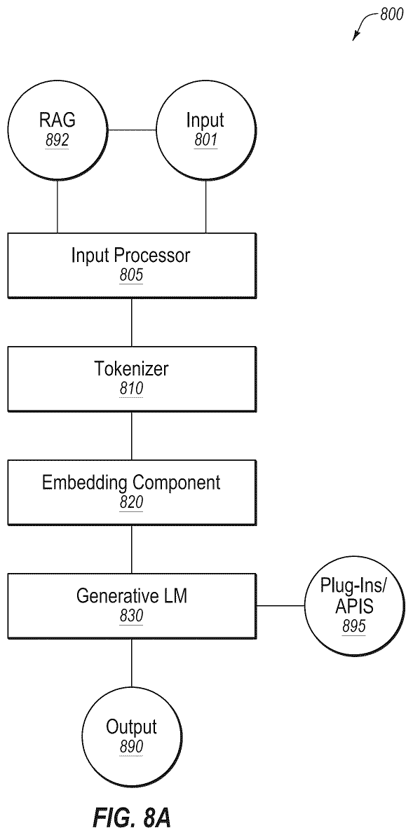

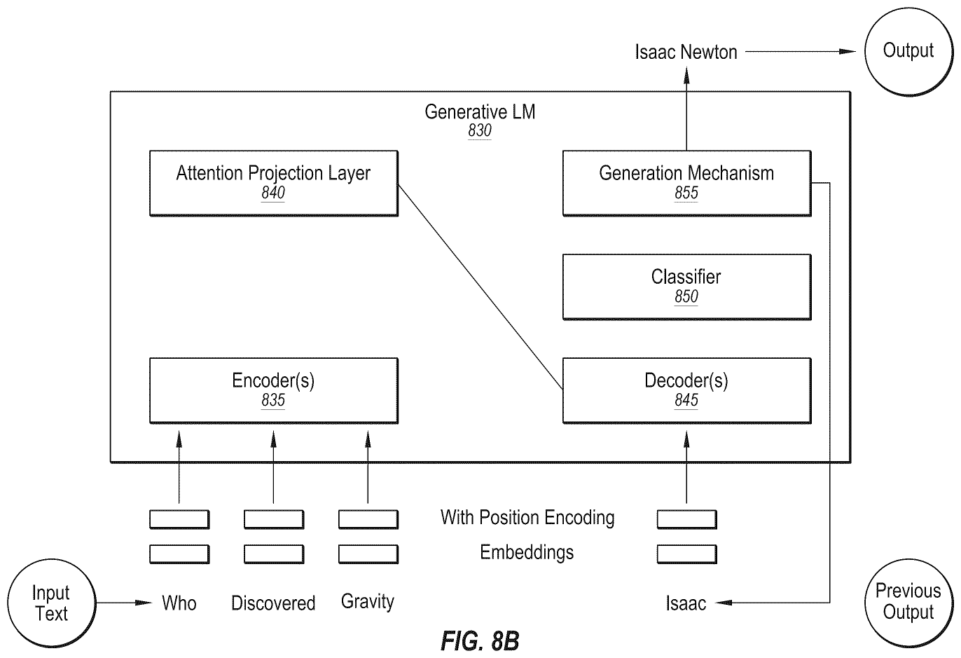

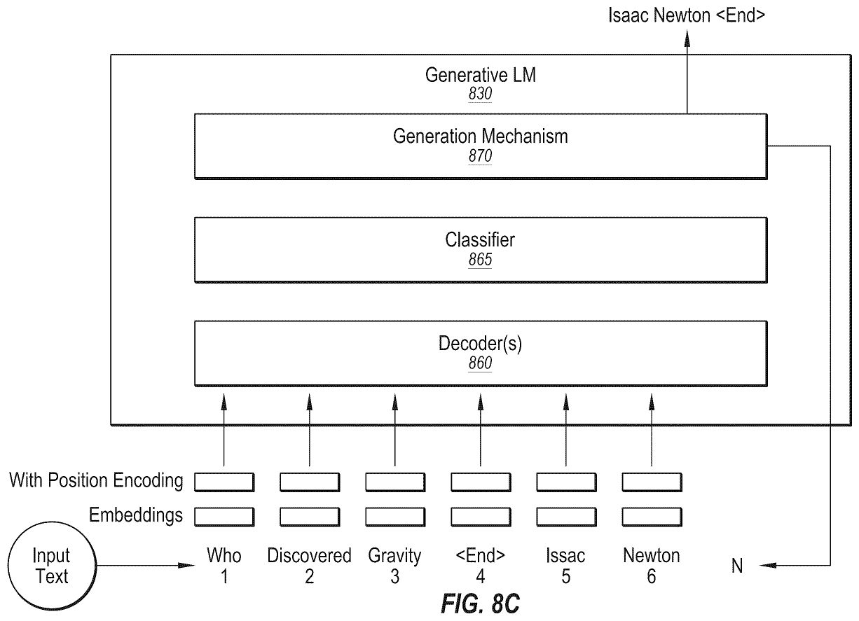

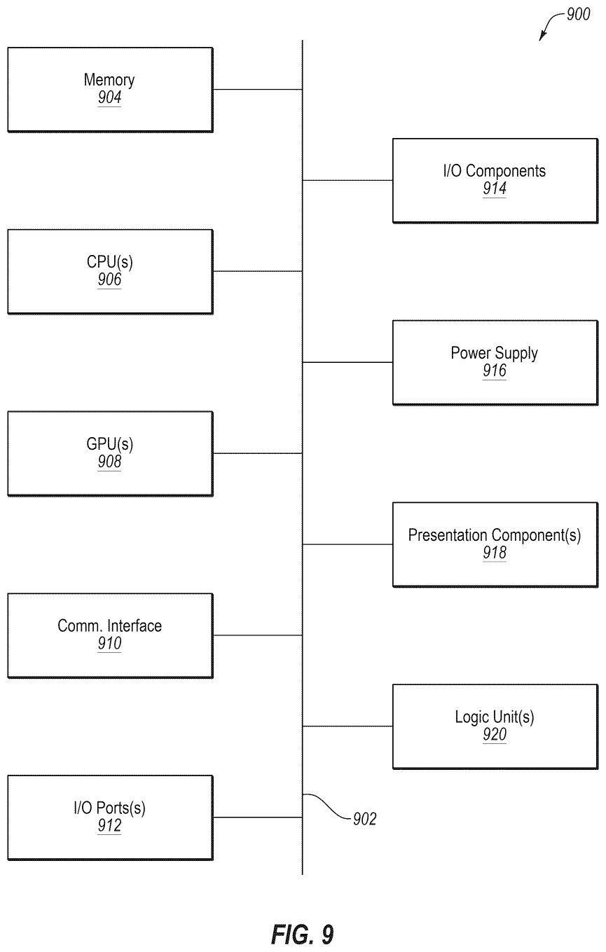

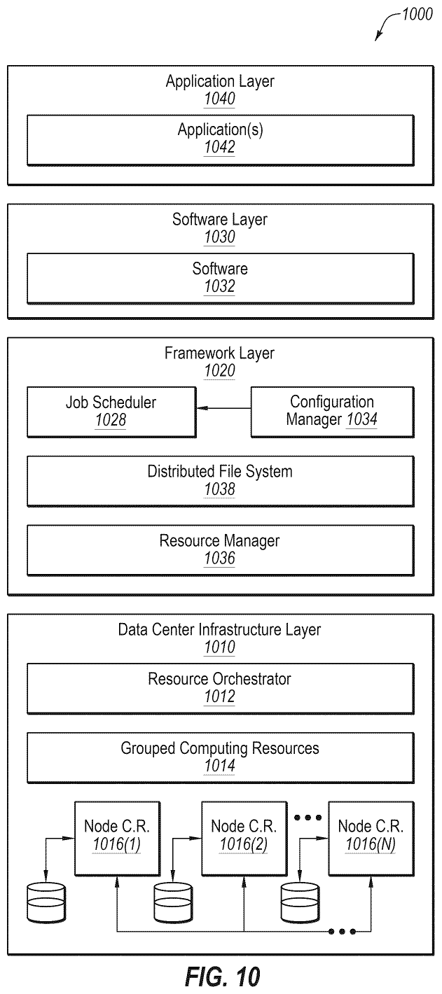

With reference to FIG. 1, FIG. 1 illustrates an example system 100 related to testing software programs, according to one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more generative language models (e.g., as described in FIGS. 8A-8C), one or more computing devices (e.g., as described in FIG. 9), and/or one or more data centers (e.g., as described in FIG. 10).

In general, the system 100 may be configured to use a generative language model (GLM) 110 to generate testing architecture 102 for a software program. The software program may include any type of software and/or collection of software that may be configured to perform operations. In some embodiments, the software program may be considered a software system that may include multiple different types of software programs and/or software modules. For example, in some embodiments, the software program may include an operating system and/or one or more software programs that are being run on the operating system.

The GLM 110 may include any suitable model that may be configured to generate language, such as a large language model (LLM), vision language model (VLM), or any other suitable model. In some embodiments, the generative language model described with respect to FIGS. 8A-8C may be an example of the GLM 110.

In these and other embodiments, the system 100 may include a test module 112. In some embodiments, the test module 112 may include code and routines configured to cause performance of the operations described with respect to the test module 112. Additionally or alternatively, the test module 112 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), one or more programmable vision accelerators (PVAs), which may include one or more vector processing units (VPUs), one or more direct memory access (DMA) systems, one or more pixel processing engines (PPEs), etc., and/or other processor types. In these and other embodiments, the test module 112 may be implemented using a combination of hardware and software. In the present disclosure, operations described as being performed by the test module 112 may include operations that the test module 112 may perform itself or cause to be performed by another device. In some embodiments, the test module 112 may be implemented using one or more generative language models (e.g., as described in FIGS. 8A-8C), one or more computing devices (e.g., as described in FIG. 9), and/or one or more data centers (e.g., as described in FIG. 10).

The test module 112 may be configured to interact with the GLM 110 to help in the generation of the testing architecture 102. For example, the test module 112 may be configured to generate one or more prompts 114 that may be provided to the GLM 110.

In general, the prompts 114 may include a set of instructions given to the GLM 110, which may guide a response of the GLM 110 and/or be used by the GLM 110 to generate text based on the content of the prompts 114. The prompts 114 may include specific information, context, questions or tasks, commands, and/or examples that the GLM 110 may use to produce a relevant output. In these and other embodiments, some elements of the prompts 114 may include context, instructions, questions or tasks, and/or examples.

The context may include background information or setting information that provides a framework for the response. The commands may include instructions or directives as to what the GLM 110 is supposed to do, such as answering a question, generating text, or completing a sentence. The questions/tasks may include queries or tasks that the model is asked to address. Further, the examples may include examples regarding expected outputs such as an expected format and/or style of the output.

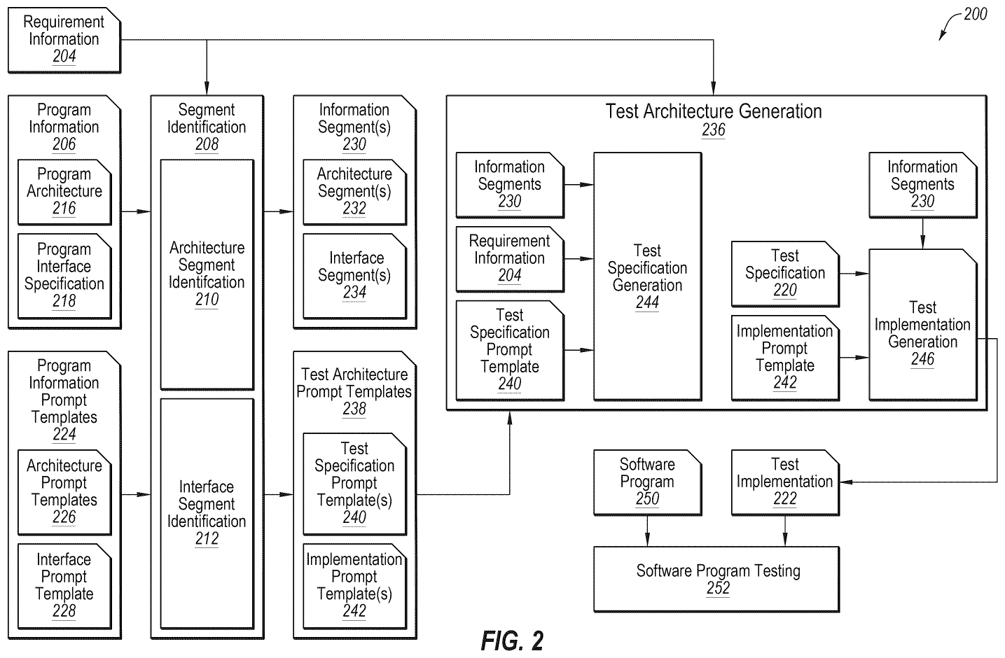

As discussed in further detail and in the context of the present disclosure, in some embodiments, the prompts 114 may be used to obtain information from the GLM 110 for the generation of the testing architecture 102. For example, the prompts 114 may include specific context information, instructions, questions, tasks, and/or examples related to one or more requirements corresponding to the software program that may cause the GLM 110 to provide information corresponding to testing whether the software program satisfies one or more requirements. As also discussed in further detail in the present disclosure, the test module 112 may be configured to interface and interact with the GLM 110 such that the testing architecture 102 may be generated. For example, FIG. 2 describes an example process that may be used to generate the testing architecture 102.

The testing architecture 102 may include a set of operations or instructions corresponding to determining whether the software program satisfies one or more requirements associated therewith. For example, in some embodiments, the testing architecture 102 may include a test specification 120 that defines behavior that may verify whether the software program satisfies a specific requirement. In these and other embodiments, the test specification may include one or more test cases that may indicate one or more verification steps that may be used for verifying such behavior. Additionally or alternatively, the testing architecture 102 may include a test implementation 122 for testing satisfaction of the requirement. The test implementation 122 may include code or routines that may implement the test specification in the programing language of the software program.

In some embodiments, the test module 112 may obtain requirement information 104, program information 106, and/or one more prompt templates 108. In these and other embodiments, the test module 112 may be configured to generate the prompts 114 based on the requirement information 104, the program information 106, and/or the prompt templates 108.

The requirement information 104 may include any suitable information that may indicate one or more requirements that may correspond to a software program. For example, in some embodiments, the requirement information 104 may indicate certain target functionality of the software program. Additionally or alternatively, the requirement information 104 may indicate one or more target performance metrics of the software program, such as response times and throughput. In these and other embodiments, the requirement information 104 may indicate target behavior of the software program in response to certain inputs. Additionally or alternatively, the requirement information 104 may indicate certain requirements related to testing of the software program, such as requirements related to types of tests to perform. For example, in some embodiments, the requirement information 104 may indicate requirements for reliability tests, fault tolerance tests, security tests, stress tests, and/or availability tests.

In some embodiments, the requirement information 104 may indicate one or more requirements by including the specific information corresponding to such requirements. Additionally or alternatively, the requirement information 104 may include one or more indicators (e.g., a code, a flag, a pointer, etc.) that may indicate from where a corresponding requirement may be obtained and/or that may be used to look up a corresponding requirement.

The test module 112 may be configured to receive the requirement information 104 and identify and/or obtain one or more requirements based on the requirement information 104. As indicated, the test module 112 may identify and/or obtain the requirements based on one or more requirements being directly included in the requirement information 104 and/or by looking up and/or acquiring one or more requirements based on corresponding indicators included in the requirement information 104.

In these and other embodiments, the requirement information 104 may include one or more fields that may indicate respective characteristics of a corresponding requirement. For example, Table 1 illustrates some example fields that may be included in the requirement information 104. The example of Table 1 is in the specific context of a software program corresponding to an automative environment (e.g., an ego machine such as described by FIGS. 11A-11D of the present disclosure). However, the example of Table 1 is not meant to be limiting and the requirement information 104 may have any number of different fields than those specifically illustrated. Further, in some embodiments, the information corresponding to one or more of the fields may be specifically included in the requirement information 104. Additionally or alternatively, the information corresponding to one or more of the fields may be obtained (e.g., received, accessed, determined, etc.) by looking up other information that may not originally be included in the requirement information 104 but that may be added to the requirement information 104 (e.g., by the test module 112) based on requirement information 104 originally provided to the test module 112.

| Field | Field Description |
|---|---|
| Requirement | A unique identifier for the requirement. |
| ID | |
| Global ID | A universal identifier that may be used across different systems or |
| | platforms. |
| Name | The title of the requirement, summarizing the functionality or feature it |
| | addresses. |
| Description | A detailed explanation of the requirement, outlining what needs to be |
| | achieved or specifying the behavior of the system. |
| Assigned To | The individual or team responsible for the requirement's implementation or |
| | verification. |
| Requirement | Specifies the type of requirement, such as functional, performance, or |
| Type | safety-related. |
| ASIL | Automotive Safety Integrity Level, indicating the safety criticality of the |
| | requirement. |
| Product/Platform | Identifies the specific product or platform to which the requirement applies. |
| SoC | Refers to the System on Chip, if applicable to the requirement. |
| Status | Indicates the current progress or resolution status of the requirement. |
| Verification | Describes how the requirement will be verified, including the test |
| Method | environment, pre-conditions, steps, and acceptance criteria. |
| Requirement | Specifies the environment in which the verification will take place, |
| Verification | indicating any specific tools, configurations, or setup required |
| Environment | |
| Pre-Condition | Lists conditions that must be in place before verification can proceed |
| Constraints | Indicates limitations or restrictions that may apply to the verification |
| | process |
| Verification | Provides a detailed, step-by-step procedure for verifying the requirement. |
| Steps | This includes the actions to be performed, the expected outcomes, and any |
| | measurements or observations to be made |
| Target Release | Specifies the software release that will include the implementation of the |
| | requirement. |

The requirement information 104 may be configured according to any suitable format. For example, in some embodiments, the requirement information 104 may be represented in the JSON (JavaScript Object Notation) format as an object with key-value pairs. Individual keys may correspond to a specific attribute of the requirement and the value may provide the details. For example, the information corresponding to the “Fields” column of Table 1 may include the keys and the information corresponding to the “Field Description” column may correspond to the value. Additionally or alternatively, the requirement information 104 may be represented in an HTML (Hypertext Markup Language) format, or any other suitable format.

In these and other embodiments, the requirement information 104 may include metadata corresponding to the substantive information about the requirement included in the requirement information 104. For example, the requirement information 104 may indicate the format in which the substantive requirement information 104 is configured (e.g., JSON, HTML, etc.).

The program information 106 may include information that may indicate one or more aspects of the software program. For example, in some embodiments, the program information 106 may include documentation that describes one or more aspects of the software program. In these and other embodiments, as discussed in further detail in the present disclosure (e.g., with respect to FIG. 2) the program information 106 may be used to identify which portions of the software program may correspond to a particular requirement, in which such portions may be used to generate the testing architecture corresponding to the particular requirement.

In some embodiments, the program information 106 may include software program architecture documentation 116 (“program architecture 116”). The program architecture 116 may include a collection of documents detailing the architecture of the software program.

For example, the program architecture 116 may include a high-level introduction to the software program, outlining its purpose, scope, and context. The introduction may include objectives that the software program may aim to achieve, such as performance, scalability, security, and/or maintainability.

In these and other embodiments, the program architecture 116 may include an architectural description. The architectural description may describe the architectural styles and patterns employed in the software program, such as microservices or layered architecture. In these and other embodiments, the architectural description may provide a high-level architecture diagram that may capture the software program's overall structure, major components, and/or their interactions.

Additionally or alternatively, the program architecture 116 may describe components and modules of the software program, where each component's responsibilities, interfaces, and interactions are explained. In these and other embodiments, the program architecture 116 may include a module view that breaks down the software program into modules or packages, illustrating dependencies and relationships among them.

In these and other embodiments, the program architecture 116 may include data architecture corresponding to the software program. The data architecture may include data models like entity-relationship diagrams (ERDs) and class diagrams, along with a description of the database architecture, such as schema, tables, and relationships.

Additionally or alternatively, the program architecture 116 may include deployment architecture corresponding to the software program. The deployment architecture may describe the deployment environment through deployment diagrams that depict hardware, network topology, and deployment nodes. In these and other embodiments, the deployment architecture may also include details on setting up and configuring different environments, like development, testing, and production.

In these and other embodiments, the program architecture 116 may include indications of interactions and behaviors of the software program. For example, the program architecture 116 may include use cases and scenarios that the software program may support. Additionally or alternatively, the use cases and scenarios may be complemented by sequence diagrams illustrating interactions between components for various scenarios, and state diagrams showing states and transitions of components or subsystems.

Additionally or alternatively, the program architecture 116 may include a technological stack section that lists the technologies, frameworks, libraries, and/or tools used in the software program. In these and other embodiments, the program architecture 116 may include indications related to design decisions and trade-offs, which may be indicated by a decision log that records architectural decisions, their rationale, and implications, and a description of the trade-offs made during the design process.

In these and other embodiments, the program architecture 116 may outline quality attributes and/or testing strategies to help ensure that attributes such as performance, security, maintainability, and usability are met. This section may also describe the approach to testing the system, including unit tests, integration tests, system tests, and performance tests. In some embodiments, such a portion of the program architecture 116 may be referenced in and/or part of the requirement information 104.

Additionally or alternatively, in some embodiments the program architecture 116 may include a glossary that provides definitions of key terms and concepts used in the documentation, and/or a references section that lists reference materials such as standards, guidelines, and external documents.

In some embodiments, the program information 106 may also include a program interface specification 118 (“interface specification 118”) corresponding to the software program. In general, the interface specification 118 may provide guidelines on how to integrate and use the interfaces corresponding to the software program to help ensure consistency and compatibility across the software program. Overall, the interface specification 118 serves as a reference document that may describe or be used to identify communication between different parts of the software program and with external entities.

For example, in some embodiments, the interface specification 118 may include a description of how different components of the software program interact with each other and with external systems. For example, the interface specification 118 may defines various interfaces, including APIs (Application Programming Interfaces), user interfaces, and communication protocols that may be used by the software program. Additionally or alternatively, the interface specification 118 may specify the methods, parameters, data formats, and/or return types corresponding to the interfaces.

In these and other embodiments, the interface specification 118 may outline the expected behavior of each interface, such as error handling, performance requirements, and security constraints. Additionally or alternatively, the interface specification 118 may include examples and use cases to illustrate typical interactions between interfaces.

In these and other embodiments, the program information 106 may include metadata corresponding to the substantive information about the program documentation included in the program information 106. For example, the program information 106 may indicate the format in which the substantive program information is configured (e.g., JSON, HTML, etc.).

The prompt templates 108 may include a framework that the test module 112 may use to generate one or more of the prompts 114. For example, in some embodiments the prompt templates 108 may include pre-populated language that provides context, asks questions, describes tasks, describes commands, and/or describes examples that may be included in the prompts 114.

In some embodiments, the test module 112 may include a generative language model and may be configured to generate at least some of the pre-populated language included in the prompt templates 108. Additionally or alternatively, at least some of the pre-populated language may be manually entered.

In these and other embodiments, the prompt templates 108 may include one or more input fields that may be populated with specific information such that corresponding pre-populated language may be directed toward specific context, questions, tasks, commands, and/or examples that are based on the information included in the fields. For example, in some embodiments, one or more of the fields may be configured to be populated with at least some of the requirement information 104. As such, the pre-populated language that corresponds to such fields may be modified to correspond to a specific requirement associated with specific requirement information 104 used to populate such fields. In the present disclosure, reference to populating a field with the “requirement information 104” may include populating the field with any information about a particular requirement that may be obtained from the requirement information 104.

In some embodiments, the prompt templates 108 may be blocks of code that may be executed by the test module 112. For example, the prompt templates 108 may include instructions that may be executed by the test module 112 that may receive certain inputs and then generate corresponding prompts based on the inputs and instructions corresponding therewith.

Additionally or alternatively, as described in further detail in the present disclosure (e.g., as discussed with respect to FIG. 2), one or more of the fields may be configured to be populated with program information 106. In the present disclosure, reference to populating a field with the “program information 106” may include populating the field with any information about the program information 106 and/or the software program itself that may be obtained from the program information 106.

In these and other embodiments and as discussed in further detail in the present disclosure (e.g., as discussed with respect to FIG. 2), one or more of the fields may be configured to be populated with additional information that may be obtained by the test module 112 during the process of generating the testing architecture 102. For example, in some embodiments, the additional information may include information output by the GLM 110 in response to receiving one or more of the prompts 114, as discussed in further detail herein.

In some embodiments, the system 100 may include a repository 124. The repository 124 may include any suitable computer-readable storage media that may be used to store information. In some embodiments, the repository 124 may operate as a local cache corresponding to the test module 112. In these and other embodiments, the repository 124 may be configured to store information related to the generation of the testing architecture. For example, the repository 124 may be configured to store information that may be obtained from outputs of the GLM 110 that are based on the prompts 114. As discussed in further detail (e.g., with respect to FIG. 2), the test module 112 may be configured to determine whether the information stored in the repository 124 may be used in the generation of subsequent testing architecture 102 for one or more other requirements. In response to determining that stored information may be used, the test module 112 may obtain such information from the repository 124 rather than generating corresponding prompts and obtaining such information from the GLM 110 based on the prompts. Accordingly, the repository 124 may help improve the efficiency of generation of some testing architecture in some instances.

The system 100 may accordingly be configured to generate the testing architecture 102 based on interactions with the GLM 110. Modifications, additions, or omissions may be made to the system 100 without departing from the scope of the present disclosure. In these and other embodiments, the prompt templates 108 may be omitted and/or very simplified in which the generative language model of the test module 112 may have a simple instruction to analyze the requirement information 104 and the program information 106 and generate the testing architecture 102 accordingly. In these and other embodiments, in some embodiments, the system 100 may be configured to perform one or more operations as discussed with respect to FIG. 2 in the generation of the testing architecture 102. Further, although the descriptions with respect to FIG. 1 and elsewhere in the present disclosure are given with respect to testing of software programs, the principles and techniques discussed may be used to generate testing architecture for any suitable computing system that may include hardware, software, and/or a combination of hardware and software.

FIG. 2 illustrates an example process 200 that may be performed to generate a testing architecture, according to one or more embodiments of the present disclosure. Each operation or block of the process 200 described herein, may comprise a computing process that may be performed using any combination of hardware, firmware, and/or software. For instance, various functions may be carried out by a processor executing instructions stored in memory. The process 200 may also be embodied as computer-usable instructions stored on computer storage media. The process 200 may be provided by a standalone application, a service or hosted service (standalone or in combination with another hosted service), as a microservice via an application programming interface (API) or a plug-in to another product, to name a few. In addition, the process 200 is described, by way of example, with respect to the system of FIG. 1. However, the process 200 may additionally or alternatively be executed by any one system, or any combination of systems, including, but not limited to, those described herein. Further, to ease explanation, the description of the process 200 is given with respect to generating testing architecture corresponding in reference to “a requirement” associated with a software program 250, however such a process may be used for the generation of testing architecture for any number of requirements for any number of software programs. The software program 250 may include any suitable software program, such as any of those described in the present disclosure.

The process 200 may include a data collection operation 202 (“data collection 202”). The data collection 202 may include gathering of information (e.g., by the test module 112 of FIG. 1) that may be used to generate a testing architecture corresponding to the requirement. For example, the data collection 202 may include obtaining (e.g., one or more of receiving, accessing, reading, etc.) requirement information 204. The requirement information 104 of FIG. 1 may be an example of the requirement information 204 in some embodiments. In these and other embodiments, the data collection 202 may include obtaining (e.g., one or more of receiving, accessing, reading, etc.) program information 206 corresponding to the software program 250. The program information 106 of FIG. 1 may be an example of the program information 206 in some embodiments. In these and other embodiments, the program information 206 may include program architecture 216, which may be similar or analogous to the program architecture 116 of FIG. 1, and/or a program interface specification 218, which may be similar or analogous to the program interface specification 118 of FIG. 1.

In some embodiments, the data collection 202 may include verifying that all the general input information that may be needed to at least begin generating the testing architecture may be obtained. For example, it may be determined that the requirement information 204 includes information corresponding to an identified requirement for which the software program 250 is to be tested. For instance, it may be determined whether the requirement information 204 includes an identifier and/or descriptive text corresponding to an identified requirement. Additionally or alternatively, in instances in which the requirement information includes an identifier for looking up a particular requirement, it may be determined whether such requirement is able to be obtained using the provided identifier. Additionally or alternatively, it may be determined that the program information 206 is sufficiently complete to be able to identify which portions of the software program 250 may correspond to the identified requirement.

In these and other embodiments, the data collection 202 may include normalizing the obtained information into a common format (e.g., plain text, JSON format, etc.). For example, the requirement information 204 and the program information 206 may be analyzed to determine whether they are in a designated format. The portions that are not in the designated format may be transformed into such format.

The process 200 may include a segment identification operation 208 (“segment identification 208”) in some embodiments. The segment identification 208 may include identifying, as one or more information segments 230, portions (also referred to as “segments”) of the program information 206 that may correspond to the requirement. For example, in some embodiments, the segment identification 208 may include identifying one or more segments of the program architecture 216 and/or one or more segments of the interface specification 218 that may correspond to the requirement.

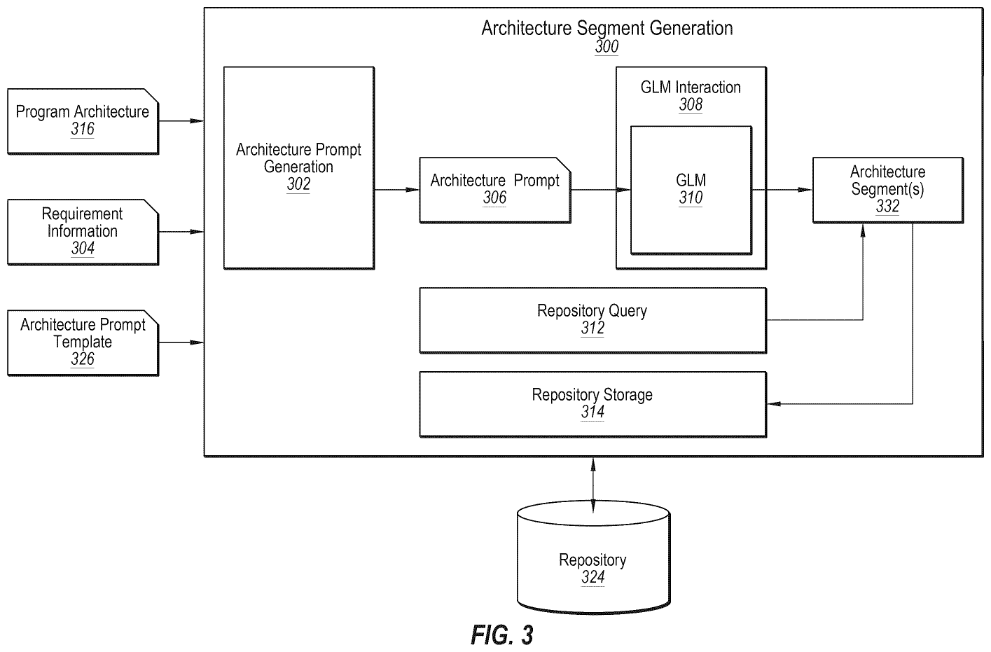

In some embodiments, the segment identification 208 may include an architecture segment identification operation 210 (“architecture segment identification 210”) configured to identify one or more architecture segments 232 that may be included in the information segments 230. The architecture segments 232 may include segments of the program architecture 216 that correspond to the requirement. In the present disclosure, reference to the “architecture segments 232” may also refer to information about where the architecture segments 232 may be accessed and accordingly may be such that the term “architecture segments 232” may not necessarily refer to the actual architecture segments but may also refer to information about the architecture segments. In some embodiments, the architecture segment identification 210 may include one or more operations described with respect to FIG. 3 of the present disclosure.

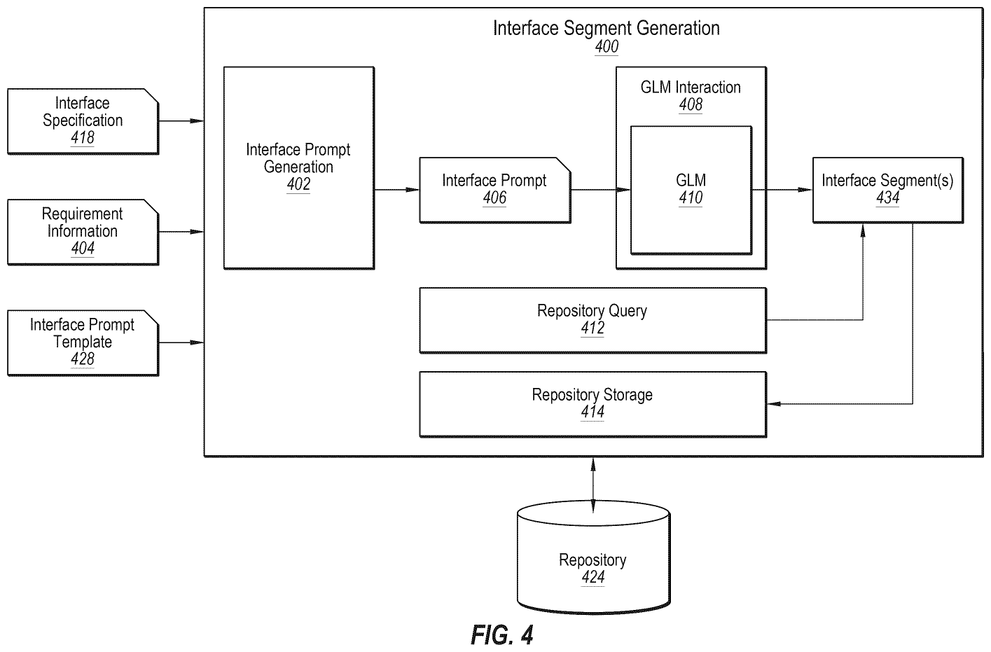

Additionally or alternatively, the segment identification 208 may include an interface segment identification operation 212 (“interface segment identification 212”) configured to identify one or more interface segments 234 that may be included in the information segments 230. The interface segments 234 may include segments of the interface specification 218 that correspond to the requirement. In the present disclosure, reference to the “interface segments 234” may also refer to information about where the interface segments 234 may be accessed and accordingly may be such that the term “interface segments 234” may not necessarily refer to the actual interface segments but may also refer to information about the architecture segments. In some embodiments, the interface specification segment identification 212 may include one or more operations described with respect to FIG. 4 of the present disclosure.

In some embodiments, the segment identification 208 may include generating one or more segment identification prompts that may be provided to a GLM—e.g., the testing module 112 of FIG. 1 may generate one or more segment identification prompts that may be provided to the GLM 110 of FIG. 1. In these and other embodiments, the segment identification prompts may be generated based on the requirement information 204, the program information 206, and one or more program information prompt templates 224.

The program information prompt templates 224 may be included in the prompt templates 108 of FIG. 1 in some embodiments. In these and other embodiments, the program information prompt templates 224 may be specifically directed toward generating prompts that may be used to obtain one or more of the program information segments 230, such as one or more program architecture segments 232 and/or one or more interface specification segments 234 that may correspond to the requirement indicated by the requirement information 204.

For example, the program information prompt templates 224 may include pre-populated language that is directed toward instructing the GLM to search for portions of the program information 206. In these and other embodiments, the program information prompt templates 224 may include input fields associated with the pre-populated language that may be configured to be populated with at least some of the requirement information 204. In these and other embodiments, the program information prompt templates 224 may include fields associated with the program information 206 that may be configured to be populated with at least some of the program information 206. The pre-populated language combined with the populated fields corresponding to the requirement information 204 and the program information 206 may accordingly result in a prompt that directs the GLM to search for portions of the program information 206, as indicated in the populated program information fields, that may correspond to the requirement, as indicated in the populated requirement information fields.

In some embodiments, the program information templates 224 may include an architecture prompt template 226. The architecture prompt template 226 may be configured to direct the GLM to search in the program architecture 216 for segments that correspond to the requirement associated with the requirement information 204. For example, the architecture prompt template 226 may be configured to receive, as inputs, information about the program architecture 216 (e.g., as indicated by the program information 206) and portions of the requirement information 204 that indicate the requirement and its corresponding format. The architecture prompt template 226 may be configured to populate various fields with such information and may include pre-populated language that interacts with such fields. The result may include generation of an architecture prompt that is configured to cause the GLM to search in the program architecture 216 for segments that correspond to the requirement associated with the requirement information 204 (e.g., the architecture segments 232).

For example, in some embodiments, the pre-populated language of the architecture prompt template 226 may include general instructions to the GLM describing that the GLM's task is to analyze the program architecture 216, as indicated by the provided input of the program architecture 216, for information related to the requirement, as indicated by the provided input of the requirement information 204. In these and other embodiments, the pre-populated language may indicate that a goal of analyzing the program architecture 216 is to extract portions of the program architecture 216 that correspond to the requirement. Additionally or alternatively, the pre-populated language may indicate for what purpose the portions of the program architecture 216 may be used such that the GLM may better identify relevant portions. In these and other embodiments, the pre-populated language may explain certain characteristics corresponding to the program architecture 216, such as the format of the program architecture 216, sections of the program architecture 216, nomenclature that may be used by the program architecture 216, etc. Additionally or alternatively, in some embodiments, the pre-populated language may include instructions related to certain types of information (e.g., comments, inline markups, etc.) that may be included in the program architecture 216 and that may be useful in identifying which portions may correspond to the requirement.

In these and other embodiments, the pre-populated language may include additional instructions related to the task at hand, such as one or more directed instructions that describe the task at hand in more detail. Additionally or alternatively, the pre-populated language may describe how the GLM may go about identifying the architecture segments 232 that correspond to the requirement. For example, the pre-populated language may include one more lists of “do's” and/or “don't's” related to identifying the architecture segments 232. In these and other embodiments, the pre-populated language may instruct the GLM regarding the format of the output that may be obtained. Additionally or alternatively, the pre-populated language may include examples corresponding to the output such as example outputs themselves, examples of what the output may look like, examples of how the output may be formatted, etc.

As discussed in further detail with respect to FIG. 3, in some embodiments, the segment identification 208 may accordingly include providing the applicable requirement information 204 and information about the program architecture 216 to the architecture prompt template 226 and executing the architecture prompt template 226 to generate the corresponding architecture prompt. The segment identification 208 may then include providing the architecture prompt to the GLM and the GLM may identify the architecture segments 232 based on the architecture prompt.

Additionally or alternatively, in some embodiments, the program information templates 224 may include an interface prompt template 228. The interface prompt template 228 may be configured to direct the GLM to search in the interface specification 218 for segments that correspond to the requirement associated with the requirement information 204. For example, the interface prompt template 228 may be configured to receive as inputs information about the interface specification 218 (e.g., as indicated by the program information 206) and portions of the requirement information 204 that indicate the requirement and its corresponding format. The interface prompt template 228 may be configured to populate various fields with such information and may include pre-populated language that interacts with such fields. The result may include generation of an interface specification prompt that is configured to cause the GLM to search in the interface specification 218 for segments that correspond to the requirement associated with the requirement information 204.

For example, in some embodiments, the pre-populated language of the interface prompt template 228 may include general instructions to the GLM describing that the GLM's task is to analyze the interface specification 218, as indicated by the provided input of the interface specification 218, for information related to the requirement, as indicated by the provided input of the requirement information 204. In these and other embodiments, the pre-populated language may indicate that a goal of analyzing the interface specification 218 is to extract portions of the interface specification 218 that correspond to the requirement. Additionally or alternatively, the pre-populated language may indicate for what purpose the portions of the interface specification 218 may be used such that the GLM may better identify relevant portions. In these and other embodiments, the pre-populated language may explain certain characteristics corresponding to the interface specification 218, such as the format of the interface specification 218, sections of the interface specification 218, nomenclature that may be used by the interface specification 218, etc. Additionally or alternatively, in some embodiments, the pre-populated language may include instructions related to certain types of information (e.g., comments, inline markups, etc.) that may be included in the interface specification 218 and that may be useful in identifying which portions may correspond to the requirement.

In these and other embodiments, the pre-populated language may include additional instructions related to the task at hand, such as one or more directed instructions that describe the task at hand in more detail. Additionally or alternatively, the pre-populated language may describe how the GLM may go about identifying the interface segments 234 that correspond to the requirement. For example, the pre-populated language may include one more lists of “do's” and/or “don't's” related to identifying the interface segments 234. In these and other embodiments, the pre-populated language may instruct the GLM regarding the format of the output that may be obtained. Additionally or alternatively, the pre-populated language may include examples corresponding to the output such as example outputs themselves, examples of what the output may look like, examples of how the output may be formatted, etc.

As discussed in further detail with respect to FIG. 4, in some embodiments, the segment identification 208 may accordingly include providing the applicable requirement information 204 and program information 206 to the interface specification prompt template 228 and executing the interface specification prompt template 228 to generate the corresponding interface specification prompt. The segment identification 208 may then include providing the interface specification prompt to the GLM and the GLM may identify the interface specification segments 234 based on the interface specification prompt.

In some embodiments, the process 200 may include a test architecture generation operation 236 (“test architecture generation 236”). In general, the test architecture generation 236 may be configured to generate one or more elements of a testing architecture, such as those described with respect the testing architecture 102 of FIG. 1. Additionally or alternatively, in some embodiments, the test architecture generation 236 may be configured to generate one or more portions of the testing architecture based on one or more of the information segments 230 (e.g., one or more of the architecture segments 232 and/or one or more of the interface segments 234), as discussed in further detail herein.

In these and other embodiments, the test architecture generation 236 may be configured to generate one or more portions of the testing architecture based on one or more test architecture prompt templates 238. The architecture prompt templates 238 may be included in the prompt templates 108 of FIG. 1 in some embodiments. In these and other embodiments, the architecture prompt templates 238 may be specifically directed toward generating prompts that may be used to obtain one or more elements of the testing architecture as described in further detail herein.

In some embodiments, the test architecture generation 236 may include a test specification generation operation 244 (“test specification generation 244”) configured to generate a test specification 220. The test specification 220 may be similar or analogous to the test specification 120 described with respect to FIG. 1. In some embodiments, the test specification generation 244 may be configured to generate the test specification 220 based on the information segments 232, the requirement information 204, and a test specification prompt template 240 that may be included in the test architecture prompt templates 238.

For example, the test specification prompt template 240 may be configured to receive as inputs, the information segments 232 and at least a portion of the requirement information 204. In these and other embodiments, the test specification prompt template 240 may include pre-populated language that is directed toward instructing the GLM to generate the test specification 220 based on the provided input.

For instance, the pre-populated language may include general instructions directing the GLM to generate a suite of test cases for a given requirement indicated by the requirement information 204 that is provided as input. In these and other embodiments, the pre-populated language may include instructions related to the format of the test cases.

Additionally or alternatively, in some embodiments, the pre-populated language may include more specific instructions directing the GLM how to go about generating the test cases. For example, the pre-populated language may instruct the GLM to parse the information segments 232, provided as input, to extract from the information segments 232, information about the software program 250 that may be useful in generating test cases corresponding to the given requirement. Additionally or alternatively, the pre-populated language may include instructions on how the GLM may begin generating the test cases and/or one more lists of “do's” and/or “don't's” related to the generation of the test specification 220.

In these and other embodiments, the pre-populated language may include certain requirements that the test cases should meet and/or specific characteristics of the test cases. Additionally or alternatively, the pre-populated language may include example test cases that the GLM may use in the generation of the test cases.

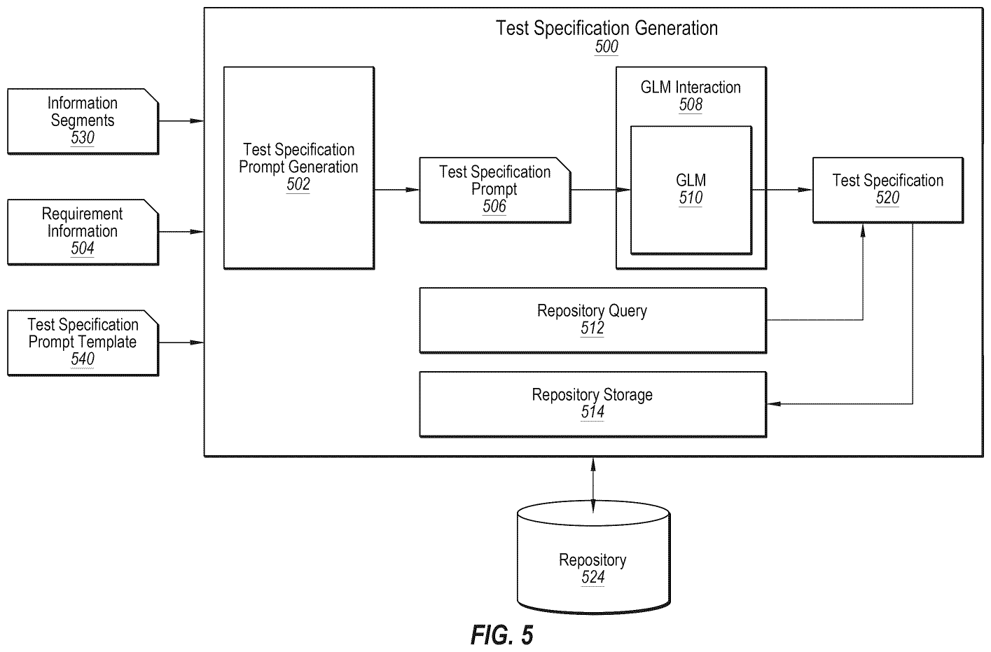

As discussed in further detail with respect to FIG. 5, in some embodiments, the test specification generation 244 may accordingly include providing the applicable requirement information 204 and information segments 230 to the test specification prompt template 240 and executing the test specification prompt template 240 to generate a corresponding test specification prompt. The test specification generation 244 may then include providing the test specification prompt to the GLM and the GLM may generate the test specification 220 based on the test specification prompt.

In some embodiments, the test architecture generation 236 may include a test implementation generation operation 246 (“test implementation generation 246”) configured to generate a test implementation 222. The test implementation 222 may be similar or analogous to the test implementation 122 described with respect to FIG. 1. In some embodiments, the test implementation generation 246 may be configured to generate the test implementation 222 based on the test specification 220, the information segments 230, and a test implementation prompt template 242 that may be included in the test architecture prompt templates 238.

For example, the test implementation prompt template 242 may be configured to receive as input the information segments 232 and the test specification 220—e.g., one or more of the test cases included in the test specification 220. In these and other embodiments, the test implementation prompt template 242 may include pre-populated language that is directed toward instructing the GLM to generate the test implementation 222 based on the provided inputs.

For instance, the pre-populated language may include general instructions directing the GLM to generate code in a particular programming language (e.g., C code) that implements the test cases of the test specification 220. In these and other embodiments, the pre-populated language may include instructions related to directing the GLM to use information included in the information segments 232 in the generation of the code.

Additionally or alternatively, in some embodiments, the pre-populated language may include more specific instructions directing the GLM how to go about generating the test cases. For example, the pre-populated language may include certain requirements that the code of the test implementation 222 should meet and/or specific characteristics of the code. Additionally or alternatively, the pre-populated language may include example test cases that the GLM may use in the generation of the test cases. Additionally or alternatively, the pre-populated language may include instructions on how the GLM may begin generating the code and/or one more lists of “do's” and/or “don't's” related to the generation of the test implementation 222. In these or other embodiments, the pre-populated language may include example code that the GLM may use in the generation of the test implementation 222.

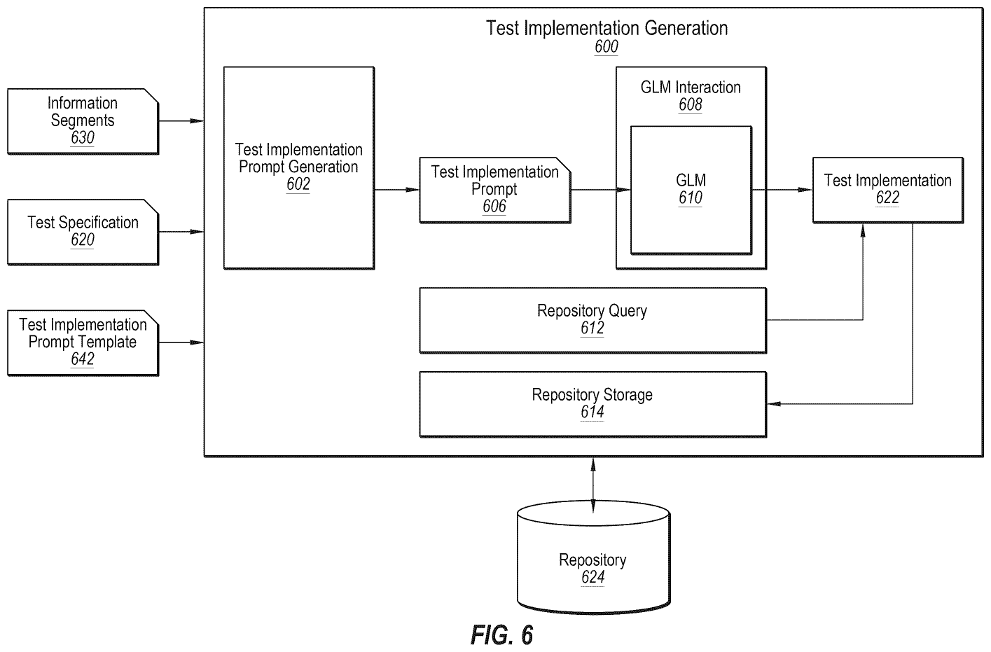

As discussed in further detail with respect to FIG. 6, in some embodiments, the test implementation generation 246 may accordingly include providing the test specification 220 and information segments 230 to the test implementation prompt template 242 and executing the test implementation prompt template 242 to generate a corresponding test implementation prompt. The test implementation generation 246 may then include providing the test implementation prompt to the GLM and the GLM may generate the test implementation 222 based on the test implementation prompt.

In some embodiments, the process 200 may include a software program testing operation 252 (“program testing 252”). In general, the program testing 252 may be configured to test the software program 250 based on the test implementation 222. For example, the software program testing 252 may include the test module 112 of FIG. 1 executing the code of the test implementation 222 with respect to the software program 250 to run the test cases included in the test specification 220.

In these and other embodiments, the program testing 252 may include evaluating a performance of the testing of the software program 250. For example, a degree of coverage of the software program 250 during the execution of the test cases in the test implementation 222 may be determined. For instance, one or more applicable test coverage techniques may be used to collect information indication which functionality of the software program 250 was covered by the test implementation 222 execution. Additionally or alternatively, it may be determined which lines of code, which percentage of the lines of code, etc., may have been covered during the execution of the test implementation 222.

In these and other embodiments, it may be determined whether the program testing 252 covered a threshold amount of the software program 250. For example, it may be determined whether a threshold percentage of the code of the software program 250 was executed and/or whether a threshold percentage of functionality was tested. The threshold amounts may vary depending on certain testing tolerances, specifications, requirements, etc. In some embodiments, the threshold amounts may be based on a heuristic analysis related to the amount of coverage and the satisfaction of such tolerances, specifications, requirements, etc.

In some embodiments, in response to determining that the threshold amount of coverage was not met, the program testing 252 may be configured to update one or more of the prompts that are generated during the process 200. For example, the program testing 252 may modify the prompts to be directed toward gaps in testing coverage that may be identified from the identified coverage results. In these and other embodiments, the updating of the prompts may result in modifications to the test implementation 222 (e.g., generation of additional code of the test implementation 222) such that the test implementation 222 may be improved based on the performance of the software program testing 252.

The process 200 may accordingly be configured to leverage one or more GLMs as part of testing the software program 250. The use of the GLMs to generate the test specification 220 and the test implementation 222 as part of the process 200 may improve the efficiency of software testing in general, which may improve the technological field of software development.

Modifications, additions, or omissions may be made to the process 200 without departing from the scope of the present disclosure. For example, although illustrated as discrete blocks or operations, various blocks or operations of the process 200 may be divided into additional blocks, combined into fewer blocks, or eliminated, depending on the particular implementations. Further, in some embodiments, one or more of the operations may be combined into fewer operations or expanded out to include additional operations.

For example, the number of prompts that are generated may vary depending on implementations. For instance, in some embodiments, two or more prompts may be combined into a single prompt. Additionally or alternatively, one or more prompts may be divided into additional prompts.

In addition, the different operations may be performed by various elements different from those described. For example, in some embodiments, one or more operations described as being performed by a test module (e.g., the test module 112 of FIG. 1) may be performed by a GLM, which may or may not be included as part of the test module. Further, in some embodiments a same GLM may be used to perform all of the operations described with respect to the GLM. Additionally or alternatively, two or more GLMs may be used.

FIG. 3 illustrates an example architecture segment identification process 300 (“process 300”), according to one or more embodiments of the present disclosure. Each operation or block of the process 300 described herein, may comprise a computing process that may be performed using any combination of hardware, firmware, and/or software. For instance, various functions may be carried out by a processor executing instructions stored in memory. The process 300 may also be embodied as computer-usable instructions stored on computer storage media. The process 300 may be provided by a standalone application, a service or hosted service (standalone or in combination with another hosted service), as a microservice via an application programming interface (API) or a plug-in to another product, to name a few. The process 300 may be performed, by way of example, by one or more elements of the system of FIG. 1, the computing device of FIG. 9, and/or the data center of FIG. 10. However, the process 300 may additionally or alternatively be executed by any one system, or any combination of systems, including, but not limited to, those described herein. Further, to ease explanation, the description of the process 300 is given with respect to identifying architecture segments in reference to “a requirement” associated with a software program, however such a process may be used for identifying architecture segments for any number of requirements for any number of software programs. The software program may include any suitable software program, such as any of those described in the present disclosure.

In addition, in some embodiments, one or more of the operations of the process 300 may be performed to perform the architecture segment identification 210 described with respect to FIG. 2. However, the process 300 is not limited only to implementations of the architecture segment identification 210.

The process 300 may include an architecture prompt generation operation 302 (“architecture prompt generation 302”) that may be used to generate an architecture prompt 306. The architecture prompt 306 may be generated based on requirement information 304, program architecture 316, and an architecture prompt template 326. The requirement information 304 may be similar or analogous to the requirement information 204 of FIG. 2, the program architecture 316 may be similar or analogous to the program architecture 216 of FIG. 2, and the architecture prompt template 326 may be similar or analogous to the architecture prompt template 226 of FIG. 2.

In some embodiments, the architecture prompt generation 302 may include providing—e.g., by the test module 112 of FIG. 1—the requirement information 304 and the program architecture 316 as inputs to the architecture prompt template 326. In the present disclosure, reference to providing the “program architecture 316” as an input may refer to references to the program architecture that may be used to identify where to find and/or access the program architecture 316.

In these and other embodiments, the architecture prompt generation 302 may include causing the architecture prompt template 326 to be executed to generate the architecture prompt 306 based on the pre-populated language of the architecture prompt template 326 and the inputted requirement information and program architecture 316.

In these and other embodiments, the process 300 may include a GLM interaction operation 308 (“GLM interaction 308”). The GLM interaction 308 may include providing the architecture prompt 306 to a GLM 310, which may be similar or analogous to the GLM 110 of FIG. 1. In these and other embodiments, the GLM 310 may identify, as architecture segments 332, one or more segments of the program architecture 316 that correspond to the requirement associated with the requirement information 304. In some embodiments, the GLM 310 may output the architecture segments 332. The architecture segments 332 may be similar or analogous to the architecture segments 232 of FIG. 2.

Additionally or alternatively, rather than and/or in addition to the architecture prompt generation 302 and the GLM interaction 308, the process 300 may include a repository query operation 312 (“repository query 312”). The repository query 312 may include accessing a repository 324. The repository 324 may be similar or analogous to the repository 124 of FIG. 1 and may include stored thereon one or more lists of one or more architecture segments that may respectively correspond to one or more requirements and/or certain requirement information. The repository 324 may also include indications of the associations between the architecture segments and the requirements and/or requirement information associated therewith.

In these and other embodiments, based on the program architecture 316 and the requirement information 304, the repository query 312 may include determining whether at least one of the architecture segments 332 are already identified and/or stored in the repository 324 in association with the requirement corresponding to the requirement information 304. Such architecture segments 332 may accordingly be identified based on the repository 324 rather than having to perform the architecture prompt generation 302 and/or the GLM interaction 308, which may help save on computing resources.

Additionally or alternatively, the process 300 may include a repository storage operation 314. The repository storage operation 314 may include storing one or more of the architecture segments 332 in association with the requirement information 304 in the repository 324. The repository storage 314 may accordingly add to the repository 324 such that future repository queries 312 may be able to use the stored information in future iterations of the process 300.

Modifications, additions, or omissions may be made to the process 300 without departing from the scope of the present disclosure. For example, although illustrated as discrete blocks or operations, various blocks or operations of the process 300 may be divided into additional blocks, combined into fewer blocks, or eliminated, depending on the particular implementations. Further, in some embodiments, one or more of the operations may be combined into fewer operations or expanded out to include additional operations.

FIG. 4 illustrates an example program interface specification segment identification process 400 (“process 400”), according to one or more embodiments of the present disclosure. Each operation or block of the process 400 described herein, may comprise a computing process that may be performed using any combination of hardware, firmware, and/or software. For instance, various functions may be carried out by a processor executing instructions stored in memory. The process 400 may also be embodied as computer-usable instructions stored on computer storage media. The process 400 may be provided by a standalone application, a service or hosted service (standalone or in combination with another hosted service), as a microservice via an application programming interface (API) or a plug-in to another product, to name a few. The process 400 may be performed, by way of example, by one or more elements of the system of FIG. 1, the computing device of FIG. 9, and/or the data center of FIG. 10. However, the process 400 may additionally or alternatively be executed by any one system, or any combination of systems, including, but not limited to, those described herein. Further, to ease explanation, the description of the process 400 is given with respect to identifying interface specification segments in reference to “a requirement” associated with a software program, however such a process may be used for identifying interface specification segments for any number of requirements for any number of software programs. The software program may include any suitable software program, such as any of those described in the present disclosure.

In addition, in some embodiments, one or more of the operations of the process 400 may be performed to perform the interface specification segment identification 212 described with respect to FIG. 2. However, the process 400 is not limited only to implementations of the interface specification segment identification 212.

The process 400 may include an interface prompt generation operation 402 (“interface prompt generation 402”) that may be used to generate an interface prompt 406. The interface prompt 406 may be generated based on requirement information 404, an interface specification 418, and an interface prompt template 428. The requirement information 404 may be similar or analogous to the requirement information 204 of FIG. 2, the interface specification 418 may be similar or analogous to the interface specification 218 of FIG. 2, and the interface prompt template 428 may be similar or analogous to the interface prompt template 228 of FIG. 2.

In some embodiments, the interface prompt generation 402 may include providing e.g., by the test module 112 of FIG. 1—the requirement information 404 and the interface specification 418 as inputs to the interface prompt template 428. In the present disclosure, reference to providing the “interface specification 418” as an input may refer to references to the interface specification that may be used to identify where to find and/or access the interface specification 418.

In some embodiments, the interface prompt generation 402 may include causing the interface prompt template 428 to be executed using the inputted requirement information 404 and interface specification 418. The execution of the interface prompt template 428 accordingly may generate the interface prompt 406 based on the pre-populated language of the interface prompt template 428 and the inputted requirement information 404 and interface specification 418.

In these and other embodiments, the process 400 may include a GLM interaction operation 408 (“GLM interaction 408”). The GLM interaction 408 may include providing the interface prompt 406 to a GLM 410, which may be similar or analogous to the GLM 110 of FIG. 1. In these and other embodiments, the GLM 410 may identify, as interface segments 434, one or more segments of the interface specification 418 that correspond to the requirement associated with the requirement information 404. In some embodiments, the GLM 410 may output the interface segments 434. The interface segments 434 may be similar or analogous to the interface segments 234 of FIG. 2 in some embodiments.

Additionally or alternatively, rather than and/or in addition to the interface prompt generation 402 and the GLM interaction 408, the process 400 may include a repository query operation 412 (“repository query 412”). The repository query 412 may include accessing a repository 424. The repository 424 may be similar or analogous to the repository 124 of FIG. 1 and may include stored thereon one or more lists of one or more interface segments that may respectively correspond to one or more requirements and/or certain requirement information. The repository 424 may also include indications of the associations between the interface segments and the requirements and/or requirement information associated therewith.

In these and other embodiments, based on the interface specification 418 and the requirement information 404, the repository query 412 may include determining whether at least one of the interface segments 434 are already identified and/or stored in the repository 424 in association with the requirement corresponding to the requirement information 404. Such interface segments 434 may accordingly be identified based on the repository 424 rather than having to perform the interface prompt generation 402 and/or the GLM interaction 408, which may help save on computing resources.

Additionally or alternatively, the process 400 may include a repository storage operation 414. The repository storage operation 414 may include storing one or more of the interface segments 434 in association with the requirement information 404 in the repository 424. The repository storage 414 may accordingly add to the repository 424 such that future repository queries 412 may be able to use the stored information in future iterations of the process 400.

Modifications, additions, or omissions may be made to the process 400 without departing from the scope of the present disclosure. For example, although illustrated as discrete blocks or operations, various blocks or operations of the process 400 may be divided into additional blocks, combined into fewer blocks, or eliminated, depending on the particular implementations. Further, in some embodiments, one or more of the operations may be combined into fewer operations or expanded out to include additional operations.

Further, in some embodiments, the repository 424 may be the same as the repository 324 of FIG. 3. Additionally or alternatively, the repository 424 may be different from the repository 324 of FIG. 3. In these and other embodiments, the GLM 410 may be the same as the GLM 310 of FIG. 3. Additionally or alternatively, the GLM 410 may be different from the GLM 310 of FIG. 3.

FIG. 5 illustrates an example test specification generation process 500 (“process 500”), according to one or more embodiments of the present disclosure. Each operation or block of the process 500 described herein, may comprise a computing process that may be performed using any combination of hardware, firmware, and/or software. For instance, various functions may be carried out by a processor executing instructions stored in memory. The process 500 may also be embodied as computer-usable instructions stored on computer storage media. The process 500 may be provided by a standalone application, a service or hosted service (standalone or in combination with another hosted service), as a microservice via an application programming interface (API) or a plug-in to another product, to name a few. The process 500 may be performed, by way of example, by one or more elements of the system of FIG. 1, the computing device of FIG. 9, and/or the data center of FIG. 10. However, the process 500 may additionally or alternatively be executed by any one system, or any combination of systems, including, but not limited to, those described herein. Further, to ease explanation, the description of the process 500 is given with respect to generating a test specification in reference to “a requirement” associated with a software program, however such a process may be used for generating test specifications for any number of requirements for any number of software programs. The software program may include any suitable software program, such as any of those described in the present disclosure.

In addition, in some embodiments, one or more of the operations of the process 500 may be performed to perform the test specification generation 244 described with respect to FIG. 2. However, the process 500 is not limited only to implementations of the test specification generation 244.

The process 500 may include test specification prompt generation operation 502 (“test specification prompt generation 502”) that may be used to generate a test specification prompt 506. The test specification prompt 506 may be generated based on requirement information 504, information segments 530, and a test specification prompt template 540. The requirement information 504 may be similar or analogous to the requirement information 204 of FIG. 2, the information segments 530 may be similar or analogous to the information segments 230 of FIG. 2, and the test specification prompt template 540 may be similar or analogous to the test specification prompt template 240 of FIG. 2.

In some embodiments, the test specification prompt generation 502 may include providing—e.g., by the test module 112 of FIG. 1—the requirement information 504 and the information segments 530 as inputs to the test specification prompt template 540. In the present disclosure, reference to providing the “information segments 530” as an input may refer to references to the information segments that may be used to identify where to find and/or access the information segments 530.

In some embodiments, the test specification prompt generation 502 may include causing the test specification prompt template 540 to be executed using the inputted requirement information 504 and information segments 530. The execution of the test specification prompt template 540 accordingly may generate the test specification prompt 506 based on the pre-populated language of the test specification prompt template 540 and the inputted requirement information 504 and information segments 530.

In these and other embodiments, the process 500 may include a GLM interaction operation 508 (“GLM interaction 508”). The GLM interaction 508 may include providing the test specification prompt 506 to a GLM 510, which may be similar or analogous to the GLM 110 of FIG. 1. In these and other embodiments, the GLM 510 may generate a test specification 520 based on the test specification prompt 506. In some embodiments, the GLM 510 may output the test specification 520. In some embodiments, the test specification 520 may be similar or analogous to the test specification 220 of FIG. 2.

Additionally or alternatively, rather than and/or in addition to the test specification prompt generation 502 and the GLM interaction 508, the process 500 may include a repository query operation 512 (“repository query 512”). The repository query 512 may include accessing a repository 524. The repository 524 may be similar or analogous to the repository 124 of FIG. 1 and may include stored thereon one or more lists of one or more test specifications and/or test cases corresponding thereto that may respectively correspond to one or more requirements and/or certain requirement information. The repository 524 may also include indications of the associations between the test specifications and/or test cases and the requirements and/or requirement information associated therewith.

In these and other embodiments, based on the requirement information 504, the repository query 512 may include determining whether at least one test case of the test specification 520 is already identified and/or stored in the repository 524 in association with the requirement corresponding to the requirement information 504. Such test cases may accordingly be identified based on the repository 524 rather than having to perform the test specification prompt generation 502 and/or the GLM interaction 508, which may help save on computing resources.

Additionally or alternatively, the process 500 may include a repository storage operation 514. The repository storage operation 514 may include storing one or more of the test cases of the test specification 520 in association with the requirement information 504 in the repository 524. The repository storage 514 may accordingly add to the repository 524 such that future repository queries 512 may be able to use the stored information in future iterations of the process 500.

Modifications, additions, or omissions may be made to the process 500 without departing from the scope of the present disclosure. For example, although illustrated as discrete blocks or operations, various blocks or operations of the process 500 may be divided into additional blocks, combined into fewer blocks, or eliminated, depending on the particular implementations. Further, in some embodiments, one or more of the operations may be combined into fewer operations or expanded out to include additional operations.

Further, in some embodiments, the repository 524 may be the same as the repository 324 of FIG. 3 and/or the repository 424 of FIG. 4. Additionally or alternatively, the repository 524 may be different from the repository 324 of FIG. 3 and/or the repository 424 of FIG. 4. In these and other embodiments, the GLM 510 may be the same as the GLM 310 of FIG. 3 and/or the GLM 410 of FIG. 4. Additionally or alternatively, the GLM 510 may be different from the GLM 310 of FIG. 3, and/or the GLM 410 of FIG. 4.

FIG. 6 illustrates an example test implementation generation process 600 (“process 600”), according to one or more embodiments of the present disclosure. Each operation or block of the process 600 described herein, may comprise a computing process that may be performed using any combination of hardware, firmware, and/or software. For instance, various functions may be carried out by a processor executing instructions stored in memory. The process 600 may also be embodied as computer-usable instructions stored on computer storage media. The process 600 may be provided by a standalone application, a service or hosted service (standalone or in combination with another hosted service), as a microservice via an application programming interface (API) or a plug-in to another product, to name a few. The process 600 may be performed, by way of example, by one or more elements of the system of FIG. 1, the computing device of FIG. 9, and/or the data center of FIG. 10. However, the process 600 may additionally or alternatively be executed by any one system, or any combination of systems, including, but not limited to, those described herein. Further, to ease explanation, the description of the process 600 is given with respect to generating a test implementation in reference to “a requirement” associated with a software program, however such a process may be used for generating test implementations for any number of requirements for any number of software programs. The software program may include any suitable software program, such as any of those described in the present disclosure.

In addition, in some embodiments, one or more of the operations of the process 600 may be performed to perform the test implementation generation 246 described with respect to FIG. 2. However, the process 600 is not limited only to implementations of the test implementation generation 246.

The process 600 may include test implementation prompt generation operation 602 (“test implementation prompt generation 602”) that may be used to generate a test implementation prompt 606. The test implementation prompt 606 may be generated based on a test specification 620, one or more information segments 630, and a test implementation prompt template 642. The test specification 620 may be similar or analogous to the test specification 220 of FIG. 2, the information segments 630 may be similar or analogous to the information segments 230 of FIG. 2, and the test implementation prompt template 642 may be similar or analogous to the test implementation prompt template 242 of FIG. 2.

In some embodiments, the test implementation prompt generation 602 may include providing—e.g., by the test module 112 of FIG. 1—the test specification 620 and the information segments 630 as inputs to the test implementation prompt template 642. In the present disclosure, reference to providing the “information segments 630” as an input may refer to references to the information segments that may be used to identify where to find and/or access the information segments 630.

In some embodiments, the test implementation prompt generation 602 may include causing the test implementation prompt template 642 to be executed using the inputted test specification 620 and information segments 630. The execution of the test implementation prompt template 642 accordingly may generate the test implementation prompt 606 based on the pre-populated language of the test implementation prompt template 642 and the inputted test specification 620 and information segments 630.

In these and other embodiments, the process 600 may include a GLM interaction operation 608 (“GLM interaction 608”). The GLM interaction 608 may include providing the test implementation prompt 606 to a GLM 610, which may be similar or analogous to the GLM 110 of FIG. 1. In these and other embodiments, the GLM 610 may generate a test implementation 622 based on the test implementation prompt 606. In some embodiments, the GLM 610 may output the test implementation 622. In some embodiments, the test implementation 622 may be similar or analogous to the test implementation 222 of FIG. 2.

Additionally or alternatively, rather than and/or in addition to the test implementation prompt generation 602 and the GLM interaction 608, the process 600 may include a repository query operation 612 (“repository query 612”). The repository query 612 may include accessing a repository 624. The repository 624 may be similar or analogous to the repository 124 of FIG. 1 and may include stored thereon one or more lists of one or more test implementations that may respectively correspond to one or more requirements and/or certain requirement information. The repository 624 may also include indications of the associations between the test implementations and the requirements and/or requirement information associated therewith. In these and other embodiments, the repository 624 may include indications of associations of the code of the test implementation 622 with respect to different test cases.

In these and other embodiments, based on the test specification 620 and/or information segments 630, the repository query 612 may include determining whether at least one set of code corresponding to at least one test case of the test specification 620 is already identified and/or stored in the repository 624. Such sets of code may accordingly be identified based on the repository 624 rather than having to perform the test implementation prompt generation 602 and/or the GLM interaction 608, which may help save on computing resources.

Additionally or alternatively, the process 600 may include a repository storage operation 614. The repository storage operation 614 may include storing one or more of sets of code of the test implementation in association with the test cases of the test specification 620 corresponding thereto. The repository storage 614 may accordingly add to the repository 624 such that future repository queries 612 may be able to use the stored information in future iterations of the process 500.

Modifications, additions, or omissions may be made to the process 600 without departing from the scope of the present disclosure. For example, although illustrated as discrete blocks or operations, various blocks or operations of the process 600 may be divided into additional blocks, combined into fewer blocks, or eliminated, depending on the particular implementations. Further, in some embodiments, one or more of the operations may be combined into fewer operations or expanded out to include additional operations.

Further, in some embodiments, the repository 624 may be the same as the repository 324 of FIG. 3, the repository 424 of FIG. 4, and/or the repository 524 of FIG. 5. Additionally or alternatively, the repository 524 may be different from the repository 324 of FIG. 3 the repository 424 of FIG. 4, and/or the repository 524 of FIG. 5. In these and other embodiments, the GLM 610 may be the same as the GLM 310 of FIG. 3, the GLM 410 of FIG. 4, and/or the GLM 510 of FIG. 5. Additionally or alternatively, the GLM 610 may be different from the GLM 310 of FIG. 3, the GLM 410 of FIG. 4, and/or the GLM 510 of FIG. 5.

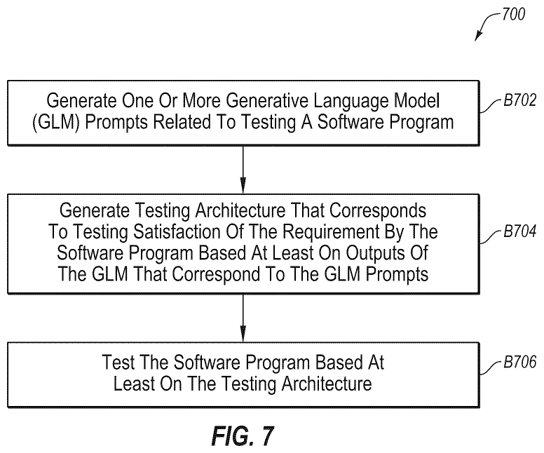

Now referring to FIG. 7, each block of method 700, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. The method 700 may be performed, by way of example, by one or more elements of the system of FIG. 1, the computing device of FIG. 9, and/or the data center of FIG. 10. However, this method may additionally or alternatively be executed by any one system, or any combination of systems, including, but not limited to, those described herein.

FIG. 7 is a flow diagram showing the method 700 for generating testing architecture for a software program, according to one or more embodiments of the present disclosure. The method 700, at block B702, includes generating one or more GLM prompts related to testing a software program. The one or more GLM prompts may be based at least on one or more prompt templates that are populated based at least on program information that describes the software program and requirement information that describes a requirement of the software program. In some embodiments, one or more of the prompts may be generated based on one or more operations described with respect to FIGS. 1-6 of the present disclosure.

At block B704, testing architecture that corresponds to satisfaction of the requirement by the software program may be generated based on one or more outputs of the GLM that correspond to the GLM prompts. In some embodiments, the testing architecture may be generated based on one or more operations described with respect to FIGS. 1-6 of the present disclosure.

At block B706, the software program may be tested based on the testing architecture in some embodiments. In some embodiments, the testing may be based on one or more operations described with respect to FIGS. 1 and 2 of the present disclosure.

Modifications, additions, or omissions may be made to the method 700 without departing from the scope of the present disclosure. For example, although illustrated as discrete blocks, various blocks of the method 700 may be divided into additional blocks, combined into fewer blocks, or eliminated, depending on the particular implementations. Further, in some embodiments the method 700 may be used to perform multiple different authentications of multiple different peripheral devices.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some embodiments of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a VLM, a multi-modal LM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 830 (e.g., LLM/VLM/MMLM/etc.). In some embodiments, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 may combine text (or may omit text) with image data, audio data, video data, design data, USD data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 892 (which may include one or more RAG models, and/or may be performed using the generative LM 830 itself) may be used to retrieve additional information to be used as part of the input 801 or prompt. RAG may be used to enhance the input to the LLM/VLM/MMLM/etc. with external knowledge, so that answers to specific questions or queries or requests are more relevant—such as in a case where specific knowledge is required. The RAG component 892 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 801 may be generated using the query or input to the model (e.g., a question, a request, etc.) in addition to data retrieved using the RAG component 892. In some embodiments, the input processor 805 may analyze the input 801 and communicate with the RAG component 892 (or the RAG component 892 may be part of the input processor 805, in embodiments) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history—or at least a summary thereof—and include the prior conversation history along with the current ask/request as part of the input 801 to the generative LM 830.

The RAG component 892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 892 and the embeddings of the chunks along with the embeddings of the query may be compared to identify the most similar/related embeddings to the query, which may be supplied to the generative LM 830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular embodiment.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 801 may resize the data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features—such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multi-modal data, the embedding component 820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some embodiments, the generative LM 830 may be configured to access or use—or capable of accessing or using—plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based on instructions in a given prompt, such as those retrieved using the RAG component 892) to access one or more plug-ins/APIs 895 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process may be repeated—e.g., recursively—for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources—such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer 810 of FIG. 8A) into tokens such as words, and each token is encoded (e.g., by the embedding component 820 of FIG. 98A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may use distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

### Example Autonomous Vehicle

FIG. 11A is an illustration of an example autonomous vehicle 1100, in accordance with some embodiments of the present disclosure. The autonomous vehicle 1100 (alternatively referred to herein as the “vehicle 1100”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1100 may be capable of functionality in accordance with one or more of Level 3-Level 5 of the autonomous driving levels. The vehicle 1100 may be capable of functionality in accordance with one or more of Level 1-Level 5 of the autonomous driving levels. For example, the vehicle 1100 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1100 or other machine, such as being fully autonomous, being highly autonomous, being conditionally autonomous, being partially autonomous, providing assistive autonomy, being semi-autonomous, being primarily autonomous, or other designation.

The vehicle 1100 may include components such as a chassis, a vehicle body, wheels (e.g., 2, 4, 6, 8, 18, etc.), tires, axles, and other components of a vehicle. The vehicle 1100 may include a propulsion system 1150, such as an internal combustion engine, hybrid electric power plant, an all-electric engine, and/or another propulsion system type. The propulsion system 1150 may be connected to a drive train of the vehicle 1100, which may include a transmission, to enable the propulsion of the vehicle 1100. The propulsion system 1150 may be controlled in response to receiving signals from the throttle/accelerator 1152.

A steering system 1154, which may include a steering wheel, may be used to steer the vehicle 1100 (e.g., along a desired path or route) when the propulsion system 1150 is operating (e.g., when the vehicle is in motion). The steering system 1154 may receive signals from a steering actuator 1156. The steering wheel may be optional for full automation (Level 5) functionality.

The brake sensor system 1146 may be used to operate the vehicle brakes in response to receiving signals from the brake actuators 1148 and/or brake sensors.

Controller(s) 1136, which may include one or more CPU(s), system on chips (SoCs) 1104 (FIG. 11C) and/or GPU(s), may provide signals (e.g., representative of commands) to one or more components and/or systems of the vehicle 1100. For example, the controller(s) may send signals to operate the vehicle brakes via one or more brake actuators 1148, to operate the steering system 1154 via one or more steering actuators 1156, and/or to operate the propulsion system 1150 via one or more throttle/accelerators 1152. The controller(s) 1136 may include one or more onboard (e.g., integrated) computing devices (e.g., supercomputers) that process sensor signals, and output operation commands (e.g., signals representing commands) to enable autonomous driving and/or to assist a human driver in driving the vehicle 1100. The controller(s) 1136 may include a first controller 1136 for autonomous driving functions, a second controller 1136 for functional safety functions, a third controller 1136 for artificial intelligence functionality (e.g., computer vision), a fourth controller 1136 for infotainment functionality, a fifth controller 1136 for redundancy in emergency conditions, and/or other controllers. In some examples, a single controller 1136 may handle two or more of the above functionalities, two or more controllers 1136 may handle a single functionality, and/or any combination thereof.

The controller(s) 1136 may provide the signals for controlling one or more components and/or systems of the vehicle 1100 in response to sensor data received from one or more sensors (e.g., sensor inputs). The sensor data may be received from, for example and without limitation, global navigation satellite systems sensor(s) 1158 (e.g., Global Positioning System sensor(s)), RADAR sensor(s) 1160, ultrasonic sensor(s) 1162, LIDAR sensor(s) 1164, inertial measurement unit (IMU) sensor(s) 1166 (e.g., accelerometer(s), gyroscope(s), magnetic compass(es), magnetometer(s), etc.), microphone(s) 1196, stereo camera(s) 1168, wide-view camera(s) 1170 (e.g., fisheye cameras), infrared camera(s) 1172, surround camera(s) 1174 (e.g., 360 degree cameras), long-range and/or mid-range camera(s) 1198, speed sensor(s) 1144 (e.g., for measuring the speed of the vehicle 1100), vibration sensor(s) 1142, steering sensor(s) 1140, brake sensor(s) 1146 (e.g., as part of the brake sensor system 1146), and/or other sensor types.

One or more of the controller(s) 1136 may receive inputs (e.g., represented by input data) from an instrument cluster 1132 of the vehicle 1100 and provide outputs (e.g., represented by output data, display data, etc.) via a human-machine interface (HMI) display 1134, an audible annunciator, a loudspeaker, and/or via other components of the vehicle 1100. The outputs may include information such as vehicle velocity, speed, time, map data (e.g., the HD map 1122 of FIG. 11C), location data (e.g., the location of the vehicle 1100, such as on a map), direction, location of other vehicles (e.g., an occupancy grid), information about objects and status of objects as perceived by the controller(s) 1136, etc. For example, the HMI display 1134 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1100 further includes a network interface 1124, which may use one or more wireless antenna(s) 1126 and/or modem(s) to communicate over one or more networks. For example, the network interface 1124 may be capable of communication over LTE, WCDMA, UMTS, GSM, CDMA2000, etc. The wireless antenna(s) 1126 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 11B is an example of camera locations and fields of view for the example autonomous vehicle 1100 of FIG. 11A, in accordance with some embodiments of the present disclosure. The cameras and respective fields of view are one example embodiment and are not intended to be limiting. For example, additional and/or alternative cameras may be included and/or the cameras may be located at different locations on the vehicle 1100.

The camera types for the cameras may include, but are not limited to, digital cameras that may be adapted for use with the components and/or systems of the vehicle 1100. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1100 (e.g., front-facing cameras) may be used for surround view, to help identify forward-facing paths and obstacles, as well aid in, with the help of one or more controllers 1136 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 1170 that may be used to perceive objects coming into view from the periphery (e.g., pedestrians, crossing traffic or bicycles). Although only one wide-view camera is illustrated in FIG. 11B, there may any number of wide-view cameras 1170 on the vehicle 1100. In addition, long-range camera(s) 1198 (e.g., a long-view stereo camera pair) may be used for depth-based object detection, especially for objects for which a neural network has not yet been trained. The long-range camera(s) 1198 may also be used for object detection and classification, as well as basic object tracking.

One or more stereo cameras 1168 may also be included in a front-facing configuration. The stereo camera(s) 1168 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 1168 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1168 may be used in addition to, or alternatively from, those described herein.

Cameras with a field of view that include portions of the environment to the side of the vehicle 1100 (e.g., side-view cameras) may be used for surround view, providing information used to create and update the occupancy grid, as well as to generate side impact collision warnings. For example, surround camera(s) 1174 (e.g., four surround cameras 1174 as illustrated in FIG. 11B) may be positioned to on the vehicle 1100. The surround camera(s) 1174 may include wide-view camera(s) 1170, fisheye camera(s), 360-degree camera(s), and/or the like. For example, four fisheye cameras may be positioned on the vehicle's front, rear, and sides. In an alternative arrangement, the vehicle may use three surround camera(s) 1174 (e.g., left, right, and rear), and may leverage one or more other camera(s) (e.g., a forward-facing camera) as a fourth surround-view camera.

Cameras with a field of view that include portions of the environment to the rear of the vehicle 1100 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1198, stereo camera(s) 1168), infrared camera(s) 1172, etc.), as described herein.

FIG. 11C is a block diagram of an example system architecture for the example autonomous vehicle 1100 of FIG. 11A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1100 in FIG. 11C is illustrated as being connected via bus 1102. The bus 1102 may include a Controller Area Network (CAN) data interface (alternatively referred to herein as a “CAN bus”). A CAN may be a network inside the vehicle 1100 used to aid in control of various features and functionality of the vehicle 1100, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1102 is described herein as being a CAN bus, this is not intended to be limiting. For example, in addition to, or alternatively from, the CAN bus, FlexRay and/or Ethernet may be used. Additionally, although a single line is used to represent the bus 1102, this is not intended to be limiting. For example, there may be any number of busses 1102, which may include one or more CAN busses, one or more FlexRay busses, one or more Ethernet busses, and/or one or more other types of busses using a different protocol. In some examples, two or more busses 1102 may be used to perform different functions, and/or may be used for redundancy. For example, a first bus 1102 may be used for collision avoidance functionality and a second bus 1102 may be used for actuation control. In any example, each bus 1102 may communicate with any of the components of the vehicle 1100, and two or more busses 1102 may communicate with the same components. In some examples, each SoC 1104, each controller 1136, and/or each computer within the vehicle may have access to the same input data (e.g., inputs from sensors of the vehicle 1100), and may be connected to a common bus, such the CAN bus.

The vehicle 1100 may include one or more controller(s) 1136, such as those described herein with respect to FIG. 11A. The controller(s) 1136 may be used for a variety of functions. The controller(s) 1136 may be coupled to any of the various other components and systems of the vehicle 1100 and may be used for control of the vehicle 1100, artificial intelligence of the vehicle 1100, infotainment for the vehicle 1100, and/or the like.

The vehicle 1100 may include a system(s) on a chip (SoC) 1104. The SoC 1104 may include CPU(s) 1106, GPU(s) 1108, processor(s) 1110, cache(s) 1112, accelerator(s) 1114, data store(s) 1116, and/or other components and features not illustrated. The SoC(s) 1104 may be used to control the vehicle 1100 in a variety of platforms and systems. For example, the SoC(s) 1104 may be combined in a system (e.g., the system of the vehicle 1100) with an HD map 1122 which may obtain map refreshes and/or updates via a network interface 1124 from one or more servers (e.g., server(s) 1178 of FIG. 11D).

The CPU(s) 1106 may include a CPU cluster or CPU complex (alternatively referred to herein as a “CCPLEX”). The CPU(s) 1106 may include multiple cores and/or L2 caches. For example, in some embodiments, the CPU(s) 1106 may include eight cores in a coherent multi-processor configuration. In some embodiments, the CPU(s) 1106 may include four dual-core clusters where each cluster has a dedicated L2 cache (e.g., a 2 MB L2 cache). The CPU(s) 1106 (e.g., the CCPLEX) may be configured to support simultaneous cluster operation enabling any combination of the clusters of the CPU(s) 1106 to be active at any given time.

The CPU(s) 1106 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1106 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1108 may include an integrated GPU (alternatively referred to herein as an “iGPU”). The GPU(s) 1108 may be programmable and may be efficient for parallel workloads. The GPU(s) 1108, in some examples, may use an enhanced tensor instruction set. The GPU(s) 1108 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1108 may include at least eight streaming microprocessors. The GPU(s) 1108 may use compute application programming interface(s) (API(s)). In addition, the GPU(s) 1108 may use one or more parallel computing platforms and/or programming models (e.g., NVIDIA's CUDA).

The GPU(s) 1108 may be power-optimized for best performance in automotive and embedded use cases. For example, the GPU(s) 1108 may be fabricated on a Fin field-effect transistor (FinFET). However, this is not intended to be limiting, and the GPU(s) 1108 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 1108 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1108 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1108 to access the CPU(s) 1106 page tables directly. In such examples, when the GPU(s) 1108 memory management unit (MMU) experiences a miss, an address translation request may be transmitted to the CPU(s) 1106. In response, the CPU(s) 1106 may look in its page tables for the virtual-to-physical mapping for the address and transmits the translation back to the GPU(s) 1108. As such, unified memory technology may allow a single unified virtual address space for memory of both the CPU(s) 1106 and the GPU(s) 1108, thereby simplifying the GPU(s) 1108 programming and porting of applications to the GPU(s) 1108.

In addition, the GPU(s) 1108 may include an access counter that may keep track of the frequency of access of the GPU(s) 1108 to memory of other processors. The access counter may help ensure that memory pages are moved to the physical memory of the processor that is accessing the pages most frequently.

The SoC(s) 1104 may include any number of cache(s) 1112, including those described herein. For example, the cache(s) 1112 may include an L3 cache that is available to both the CPU(s) 1106 and the GPU(s) 1108 (e.g., that is connected to both the CPU(s) 1106 and the GPU(s) 1108). The cache(s) 1112 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1104 may include an arithmetic logic unit(s) (ALU(s)) which may be leveraged in performing processing with respect to any of the variety of tasks or operations of the vehicle 1100—such as processing DNNs. In addition, the SoC(s) 1104 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1106 and/or GPU(s) 1108.

The SoC(s) 1104 may include one or more accelerators 1114 (e.g., hardware accelerators, software accelerators, or a combination thereof). For example, the SoC(s) 1104 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1108 and to off-load some of the tasks of the GPU(s) 1108 (e.g., to free up more cycles of the GPU(s) 1108 for performing other tasks). As an example, the accelerator(s) 1114 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1114 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1108, and by using an inference accelerator, for example, a designer may target either the DLA(s) or the GPU(s) 1108 for any function. For example, the designer may focus processing of CNNs and floating point operations on the DLA(s) and leave other functions to the GPU(s) 1108 and/or other accelerator(s) 1114.

The accelerator(s) 1114 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1106. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1114 (e.g., the hardware acceleration cluster) may include a computer vision network on-chip and SRAM, for providing a high-bandwidth, low latency SRAM for the accelerator(s) 1114. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1104 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1114 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1166 output that correlates with the vehicle 1100 orientation, distance, 3D location estimates of the object obtained from the neural network and/or other sensors (e.g., LIDAR sensor(s) 1164 or RADAR sensor(s) 1160), among others.

The SoC(s) 1104 may include data store(s) 1116 (e.g., memory). The data store(s) 1116 may be on-chip memory of the SoC(s) 1104, which may store neural networks to be executed on the GPU and/or the DLA. In some examples, the data store(s) 1116 may be large enough in capacity to store multiple instances of neural networks for redundancy and safety. The data store(s) 1116 may comprise L2 or L3 cache(s) 1112. Reference to the data store(s) 1116 may include reference to the memory associated with the PVA, DLA, and/or other accelerator(s) 1114, as described herein.

The SoC(s) 1104 may include one or more processor(s) 1110 (e.g., embedded processors). The processor(s) 1110 may include a boot and power management processor that may be a dedicated processor and subsystem to handle boot power and management functions and related security enforcement. The boot and power management processor may be a part of the SoC(s) 1104 boot sequence and may provide runtime power management services. The boot power and management processor may provide clock and voltage programming, assistance in system low power state transitions, management of SoC(s) 1104 thermals and temperature sensors, and/or management of the SoC(s) 1104 power states. Each temperature sensor may be implemented as a ring-oscillator whose output frequency is proportional to temperature, and the SoC(s) 1104 may use the ring-oscillators to detect temperatures of the CPU(s) 1106, GPU(s) 1108, and/or accelerator(s) 1114. If temperatures are determined to exceed a threshold, the boot and power management processor may enter a temperature fault routine and put the SoC(s) 1104 into a lower power state and/or put the vehicle 1100 into a chauffeur to safe-stop mode (e.g., bring the vehicle 1100 to a safe stop).

The processor(s) 1110 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1110 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 1110 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1110 may further include a real-time camera engine that may include a dedicated processor subsystem for handling real-time camera management.

The processor(s) 1110 may further include a high dynamic range signal processor that may include an image signal processor that is a hardware engine that is part of the camera processing pipeline.

The processor(s) 1110 may include a video image compositor that may be a processing block (e.g., implemented on a microprocessor) that implements video post-processing functions needed by a video playback application to produce the final image for the player window. The video image compositor may perform lens distortion correction on wide-view camera(s) 1170, surround camera(s) 1174, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1108 is not required to continuously render new surfaces. Even when the GPU(s) 1108 is powered on and active doing 3D rendering, the video image compositor may be used to offload the GPU(s) 1108 to improve performance and responsiveness.

The SoC(s) 1104 may further include a mobile industry processor interface (MIPI) camera serial interface for receiving video and input from cameras, a high-speed interface, and/or a video input block that may be used for camera and related pixel input functions. The SoC(s) 1104 may further include an input/output controller(s) that may be controlled by software and may be used for receiving I/O signals that are uncommitted to a specific role.

The SoC(s) 1104 may further include a broad range of peripheral interfaces to enable communication with peripherals, audio codecs, power management, and/or other devices. The SoC(s) 1104 may be used to process data from cameras (e.g., connected over Gigabit Multimedia Serial Link and Ethernet), sensors (e.g., LIDAR sensor(s) 1164, RADAR sensor(s) 1160, etc. that may be connected over Ethernet), data from bus 1102 (e.g., speed of vehicle 1100, steering wheel position, etc.), data from GNSS sensor(s) 1158 (e.g., connected over Ethernet or CAN bus). The SoC(s) 1104 may further include dedicated high-performance mass storage controllers that may include their own DMA engines, and that may be used to free the CPU(s) 1106 from routine data management tasks.

The SoC(s) 1104 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1104 may be faster, more reliable, and even more energy-efficient and space-efficient than conventional systems. For example, the accelerator(s) 1114, when combined with the CPU(s) 1106, the GPU(s) 1108, and the data store(s) 1116, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1120) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1108.

In some examples, a CNN for facial recognition and vehicle owner identification may use data from camera sensors to identify the presence of an authorized driver and/or owner of the vehicle 1100. The always-on sensor processing engine may be used to unlock the vehicle when the owner approaches the driver door and turn on the lights, and, in security mode, to disable the vehicle when the owner leaves the vehicle. In this way, the SoC(s) 1104 provide for security against theft and/or carjacking.

In another example, a CNN for emergency vehicle detection and identification may use data from microphones 1196 to detect and identify emergency vehicle sirens. In contrast to conventional systems, that use general classifiers to detect sirens and manually extract features, the SoC(s) 1104 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1158. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1162, until the emergency vehicle(s) passes.

The vehicle may include a CPU(s) 1118 (e.g., discrete CPU(s), or dCPU(s)), that may be coupled to the SoC(s) 1104 via a high-speed interconnect (e.g., PCIe). The CPU(s) 1118 may include an X86 processor, for example. The CPU(s) 1118 may be used to perform any of a variety of functions, including arbitrating potentially inconsistent results between ADAS sensors and the SoC(s) 1104, and/or monitoring the status and health of the controller(s) 1136 and/or infotainment SoC 1130, for example.

The vehicle 1100 may include a GPU(s) 1120 (e.g., discrete GPU(s), or dGPU(s)), that may be coupled to the SoC(s) 1104 via a high-speed interconnect (e.g., NVIDIA's NVLINK). The GPU(s) 1120 may provide additional artificial intelligence functionality, such as by executing redundant and/or different neural networks, and may be used to train and/or update neural networks based on input (e.g., sensor data) from sensors of the vehicle 1100.

The vehicle 1100 may further include the network interface 1124 which may include one or more wireless antennas 1126 (e.g., one or more wireless antennas for different communication protocols, such as a cellular antenna, a Bluetooth antenna, etc.). The network interface 1124 may be used to enable wireless connectivity over the Internet with the cloud (e.g., with the server(s) 1178 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1100 information about vehicles in proximity to the vehicle 1100 (e.g., vehicles in front of, on the side of, and/or behind the vehicle 1100). This functionality may be part of a cooperative adaptive cruise control functionality of the vehicle 1100.

The network interface 1124 may include a SoC that provides modulation and demodulation functionality and enables the controller(s) 1136 to communicate over wireless networks. The network interface 1124 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1100 may further include data store(s) 1128, which may include off-chip (e.g., off the SoC(s) 1104) storage. The data store(s) 1128 may include one or more storage elements including RAM, SRAM, DRAM, VRAM, Flash, hard disks, and/or other components and/or devices that may store at least one bit of data.

The vehicle 1100 may further include GNSS sensor(s) 1158. The GNSS sensor(s) 1158 (e.g., GPS, assisted GPS sensors, differential GPD (DGPS) sensors, etc.), to assist in mapping, perception, occupancy grid generation, and/or path planning functions. Any number of GNSS sensor(s) 1158 may be used, including, for example and without limitation, a GPS using a USB connector with an Ethernet to Serial (RS-232) bridge.

The vehicle 1100 may further include RADAR sensor(s) 1160. The RADAR sensor(s) 1160 may be used by the vehicle 1100 for long-range vehicle detection, even in darkness and/or severe weather conditions. RADAR functional safety levels may be ASIL B. The RADAR sensor(s) 1160 may use the CAN and/or the bus 1102 (e.g., to transmit data generated by the RADAR sensor(s) 1160) for control and to access object tracking data, with access to Ethernet to access raw data, in some examples. A wide variety of RADAR sensor types may be used. For example, and without limitation, the RADAR sensor(s) 1160 may be suitable for front, rear, and side RADAR use. In some example, Pulse Doppler RADAR sensor(s) are used.

The RADAR sensor(s) 1160 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1160 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1100 surrounding at higher speeds with minimal interference from traffic in adjacent lanes. The other two antennae may expand the field of view, making it possible to quickly detect vehicles entering or leaving the vehicle's 1100 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1100 may further include ultrasonic sensor(s) 1162. The ultrasonic sensor(s) 1162, which may be positioned at the front, back, and/or the sides of the vehicle 1100, may be used for park assist and/or to create and update an occupancy grid. A wide variety of ultrasonic sensor(s) 1162 may be used, and different ultrasonic sensor(s) 1162 may be used for different ranges of detection (e.g., 2.5 m, 4 m). The ultrasonic sensor(s) 1162 may operate at functional safety levels of ASIL B.

The vehicle 1100 may include LIDAR sensor(s) 1164. The LIDAR sensor(s) 1164 may be used for object and pedestrian detection, emergency braking, collision avoidance, and/or other functions. The LIDAR sensor(s) 1164 may be functional safety level ASIL B. In some examples, the vehicle 1100 may include multiple LIDAR sensors 1164 (e.g., two, four, six, etc.) that may use Ethernet (e.g., to provide data to a Gigabit Ethernet switch).

In some examples, the LIDAR sensor(s) 1164 may be capable of providing a list of objects and their distances for a 360-degree field of view. Commercially available LIDAR sensor(s) 1164 may have an advertised range of approximately 100 m, with an accuracy of 2 cm-3 cm, and with support for a 100 Mbps Ethernet connection, for example. In some examples, one or more non-protruding LIDAR sensors 1164 may be used. In such examples, the LIDAR sensor(s) 1164 may be implemented as a small device that may be embedded into the front, rear, sides, and/or corners of the vehicle 1100. The LIDAR sensor(s) 1164, in such examples, may provide up to a 120-degree horizontal and 35-degree vertical field-of-view, with a 200 m range even for low-reflectivity objects. Front-mounted LIDAR sensor(s) 1164 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1100. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1164 may be less susceptible to motion blur, vibration, and/or shock.

The vehicle may further include IMU sensor(s) 1166. The IMU sensor(s) 1166 may be located at a center of the rear axle of the vehicle 1100, in some examples. The IMU sensor(s) 1166 may include, for example and without limitation, an accelerometer(s), a magnetometer(s), a gyroscope(s), a magnetic compass(es), and/or other sensor types. In some examples, such as in six-axis applications, the IMU sensor(s) 1166 may include accelerometers and gyroscopes, while in nine-axis applications, the IMU sensor(s) 1166 may include accelerometers, gyroscopes, and magnetometers.

In some embodiments, the IMU sensor(s) 1166 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1166 may enable the vehicle 1100 to estimate heading without requiring input from a magnetic sensor by directly observing and correlating the changes in velocity from GPS to the IMU sensor(s) 1166. In some examples, the IMU sensor(s) 1166 and the GNSS sensor(s) 1158 may be combined in a single integrated unit.

The vehicle may include microphone(s) 1196 placed in and/or around the vehicle 1100. The microphone(s) 1196 may be used for emergency vehicle detection and identification, among other things.

The vehicle may further include any number of camera types, including stereo camera(s) 1168, wide-view camera(s) 1170, infrared camera(s) 1172, surround camera(s) 1174, long-range and/or mid-range camera(s) 1198, and/or other camera types. The cameras may be used to capture image data around an entire periphery of the vehicle 1100. The types of cameras used depends on the embodiments and requirements for the vehicle 1100, and any combination of camera types may be used to provide the necessary coverage around the vehicle 1100. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 11A and FIG. 11B.

The vehicle 1100 may further include vibration sensor(s) 1142. The vibration sensor(s) 1142 may measure vibrations of components of the vehicle, such as the axle(s). For example, changes in vibrations may indicate a change in road surfaces. In another example, when two or more vibration sensors 1142 are used, the differences between the vibrations may be used to determine friction or slippage of the road surface (e.g., when the difference in vibration is between a power-driven axle and a freely rotating axle).

The vehicle 1100 may include an ADAS system 1138. The ADAS system 1138 may include a SoC, in some examples. The ADAS system 1138 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1160, LIDAR sensor(s) 1164, and/or a camera(s). The ACC systems may include longitudinal ACC and/or lateral ACC. Longitudinal ACC monitors and controls the distance to the vehicle immediately ahead of the vehicle 1100 and automatically adjust the vehicle speed to maintain a safe distance from vehicles ahead. Lateral ACC performs distance keeping, and advises the vehicle 1100 to change lanes when necessary. Lateral ACC is related to other ADAS applications such as LCA and CWS.

CACC uses information from other vehicles that may be received via the network interface 1124 and/or the wireless antenna(s) 1126 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1100), while the I2V communication concept provides information about traffic further ahead. CACC systems may include either or both I2V and V2V information sources. Given the information of the vehicles ahead of the vehicle 1100, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 1160, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1160, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1100 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1100 if the vehicle 1100 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 1100 is backing up. Some RCTW systems include AEB to ensure that the vehicle brakes are applied to avoid a crash. RCTW systems may use one or more rear-facing RADAR sensor(s) 1160, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 1100, the vehicle 1100 itself must, in the case of conflicting results, decide whether to heed the result from a primary computer or a secondary computer (e.g., a first controller 1136 or a second controller 1136). For example, in some embodiments, the ADAS system 1138 may be a backup and/or secondary computer for providing perception information to a backup computer rationality module. The backup computer rationality monitor may run a redundant diverse software on hardware components to detect faults in perception and dynamic driving tasks. Outputs from the ADAS system 1138 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1104.

In other examples, ADAS system 1138 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1138 may be fed into the primary computer's perception block and/or the primary computer's dynamic driving task block. For example, if the ADAS system 1138 indicates a forward crash warning due to an object immediately ahead, the perception block may use this information when identifying objects. In other examples, the secondary computer may have its own neural network that is trained and thus reduces the risk of false positives, as described herein.

The vehicle 1100 may further include the infotainment SoC 1130 (e.g., an in-vehicle infotainment system (IVI)). Although illustrated and described as an SoC, the infotainment system may not be a SoC, and may include two or more discrete components. The infotainment SoC 1130 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 1100. For example, the infotainment SoC 1130 may include radios, disk players, navigation systems, video players, USB and Bluetooth connectivity, carputers, in-car entertainment, Wi-Fi, steering wheel audio controls, hands-free voice control, a heads-up display (HUD), an HMI display 1134, a telematics device, a control panel (e.g., for controlling and/or interacting with various components, features, and/or systems), and/or other components. The infotainment SoC 1130 may further be used to provide information (e.g., visual and/or audible) to a user(s) of the vehicle, such as information from the ADAS system 1138, autonomous driving information such as planned vehicle maneuvers, trajectories, surrounding environment information (e.g., intersection information, vehicle information, road information, etc.), and/or other information.

The infotainment SoC 1130 may include GPU functionality. The infotainment SoC 1130 may communicate over the bus 1102 (e.g., CAN bus, Ethernet, etc.) with other devices, systems, and/or components of the vehicle 1100. In some examples, the infotainment SoC 1130 may be coupled to a supervisory MCU such that the GPU of the infotainment system may perform some self-driving functions in the event that the primary controller(s) 1136 (e.g., the primary and/or backup computers of the vehicle 1100) fail. In such an example, the infotainment SoC 1130 may put the vehicle 1100 into a chauffeur to safe-stop mode, as described herein.

The vehicle 1100 may further include an instrument cluster 1132 (e.g., a digital dash, an electronic instrument cluster, a digital instrument panel, etc.). The instrument cluster 1132 may include a controller and/or supercomputer (e.g., a discrete controller or supercomputer). The instrument cluster 1132 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1130 and the instrument cluster 1132. In other words, the instrument cluster 1132 may be included as part of the infotainment SoC 1130, or vice versa.

FIG. 11D is a system diagram for communication between cloud-based server(s) and the example autonomous vehicle 1100 of FIG. 11A, in accordance with some embodiments of the present disclosure. The system 1176 may include server(s) 1178, network(s) 1190, and vehicles, including the vehicle 1100. The server(s) 1178 may include a plurality of GPUs 1184(A)-1184(H) (collectively referred to herein as GPUs 1184), PCIe switches 1182(A)-1182(H) (collectively referred to herein as PCIe switches 1182), and/or CPUs 1180(A)-1180(B) (collectively referred to herein as CPUs 1180). The GPUs 1184, the CPUs 1180, and the PCIe switches may be interconnected with high-speed interconnects such as, for example and without limitation, NVLink interfaces 1188 developed by NVIDIA and/or PCIe connections 1186. In some examples, the GPUs 1184 are connected via NVLink and/or NVSwitch SoC and the GPUs 1184 and the PCIe switches 1182 are connected via PCIe interconnects. Although eight GPUs 1184, two CPUs 1180, and two PCIe switches are illustrated, this is not intended to be limiting. Depending on the embodiment, each of the server(s) 1178 may include any number of GPUs 1184, CPUs 1180, and/or PCIe switches. For example, the server(s) 1178 may each include eight, sixteen, thirty-two, and/or more GPUs 1184.

The server(s) 1178 may receive, over the network(s) 1190 and from the vehicles, image data representative of images showing unexpected or changed road conditions, such as recently commenced road work. The server(s) 1178 may transmit, over the network(s) 1190 and to the vehicles, neural networks 1192, updated neural networks 1192, and/or map information 1194, including information regarding traffic and road conditions. The updates to the map information 1194 may include updates for the HD map 1122, such as information regarding construction sites, potholes, detours, flooding, and/or other obstructions. In some examples, the neural networks 1192, the updated neural networks 1192, and/or the map information 1194 may have resulted from new training and/or experiences represented in data received from any number of vehicles in the environment, and/or based on training performed at a datacenter (e.g., using the server(s) 1178 and/or other servers).

The server(s) 1178 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1190, and/or the machine learning models may be used by the server(s) 1178 to remotely monitor the vehicles.

In some examples, the server(s) 1178 may receive data from the vehicles and apply the data to up-to-date real-time neural networks for real-time intelligent inferencing. The server(s) 1178 may include deep-learning supercomputers and/or dedicated AI computers powered by GPU(s) 1184, such as a DGX and DGX Station machines developed by NVIDIA. However, in some examples, the server(s) 1178 may include deep learning infrastructure that use only CPU-powered datacenters.

The deep-learning infrastructure of the server(s) 1178 may be capable of fast, real-time inferencing, and may use that capability to evaluate and verify the health of the processors, software, and/or associated hardware in the vehicle 1100. For example, the deep-learning infrastructure may receive periodic updates from the vehicle 1100, such as a sequence of images and/or objects that the vehicle 1100 has located in that sequence of images (e.g., via computer vision and/or other machine learning object classification techniques). The deep-learning infrastructure may run its own neural network to identify the objects and compare them with the objects identified by the vehicle 1100 and, if the results do not match and the infrastructure concludes that the AI in the vehicle 1100 is malfunctioning, the server(s) 1178 may transmit a signal to the vehicle 1100 instructing a fail-safe computer of the vehicle 1100 to assume control, notify the passengers, and complete a safe parking maneuver.

For inferencing, the server(s) 1178 may include the GPU(s) 1184 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The subject technology of the present disclosure is illustrated, for example, according to various aspects described below. Various examples of aspects of the present disclosure are described as numbered examples (1, 2, 3, etc.) for convenience. These are provided as examples and do not limit the present disclosure. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example The following is a non-limiting summary of some example implementations presented herein.

Example 1. A method comprising:
generating one or more generative language model (GLM) prompts related to testing a software program, the one or more GLM prompts being based at least on one or more prompt templates that are populated based at least on program information that describes the software program and requirement information that describes a requirement of the software program;
generating testing architecture that corresponds to testing satisfaction of the requirement by the software program based at least on one or more outputs of the GLM that correspond to the one or more GLM prompts; and
testing the software program based at least on the testing architecture.

Example 2. The method of Example 1, wherein:
the generating of the one or more GLM prompts includes generating a first prompt at least by populating a first prompt template based at least on the program information and the requirement information; and
the one or more outputs of the GLM include a first output that is based at least on the first prompt and that identifies one or more segments of the program information that correspond to the requirement.

Example 3. The method of Example 2, wherein:
the generating of the one or more GLM prompts includes generating a second prompt at least by populating a second prompt template based at least on the requirement and the one or more segments; and
the one or more outputs of the GLM include a second output that is based at least on the second prompt and that identifies a test specification that corresponds to the requirement and that is included in the testing architecture.

Example 4. The method of Example 3, wherein:
the generating of the one or more GLM prompts includes generating a third prompt at least by populating a third prompt template based at least on the one or more segments and the test specification; and
the one or more outputs of the GLM include a third output that is based at least on the third prompt and that identifies test code that corresponds to the testing architecture.

Example 5. The method of Example 4, further comprising saving, as one or more entries in a repository, one or more of:
the first output of the GLM in association with the requirement information and the program information;
the second output of the GLM in association with the requirement information and the one or more segments; or
the third output of the GLM in association with the test specification.

Example 6. The method of Example 1, further comprising evaluating performance of the testing of the software program.

Example 7. The method of Example 6, wherein the evaluating of the performance of the testing includes determining a degree of code coverage corresponding to the testing.

Example 8. The method of Example 6, further comprising generating additional test code based at least on the performance as evaluated.

Example 9. The method of Example 7, wherein the additional test code is generated based at least on one or more additional GLM prompts that are based at least on the performance of the testing.

Example 10. The method of Example 1, wherein the program information includes one or more of:
architecture documentation describing components of the software program and interactions between the components; or
interface specification documentation describing specific implementation details corresponding to the components.

Example 11. A system comprising:
one or more processors to perform operations comprising:
   generating a first prompt based at least on a first prompt template, program information that describes a software program, and requirement information that describes a requirement of the software program;
   extracting one or more program information segments of the program information that relate to the requirement based at least on a first output of a generative language model (GLM) that is based at least on the first prompt;
   generating a second prompt based at least on a second prompt template, the requirement information, and the one or more segments;
   obtaining a test specification that corresponds to the requirement based at least on a second output of the GLM that is based at least on the second prompt;
   generating a third prompt based at least on a third prompt template, the one or more segments, and the test specification;
   obtaining a test implementation that corresponds to testing satisfaction of the requirement by the software program based at least on a third output of the GLM that is based at least on the third prompt; and
   performing a test of the software program based at least on the test implementation.

Example 12. The system of Example 11, further comprising saving, as one or more entries in a repository, one or more of:
the first output of the GLM in association with the requirement information and the program information;
the second output of the GLM in association with the requirement information and the one or more segments; or
the third output of the GLM in association with the test specification.

Example 13. The system of Example 11, wherein the program information includes one or more of:
architecture documentation describing components of the software program and interactions between the components; or
interface specification documentation describing specific implementation details corresponding to the components.

Example 14. The system of Example 11, wherein the operations further comprise generating additional test code based at least on a performance of the testing of the software program.

Example 15. The system of Example 11, wherein the second template includes one or more example test specifications.

Example 16. The system of Example 11, wherein the third template includes one or more example test implementations.

Example 17. The system of Example 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.

Example 18. One or more processors comprising:
processing circuitry to perform operations comprising:
   generating a first prompt at least by populating a first prompt template based at least on program information that describes a software program and requirement information that describes a requirement of the software program, the first prompt corresponding to identifying portions of the program information that relate to the requirement;
   extracting one or more segments of the program information that relate to the requirement based at least on a first output of a generative language model (GLM) that corresponds to the first prompt;
   generating a second prompt at least by populating a second prompt template based at least on the requirement and the one or more segments, the second prompt corresponding to identification of behavior of the software program that is associated with satisfaction of the requirement;
   obtaining a test specification that corresponds to the requirement based at least on a second output of the GLM that corresponds to the second prompt;
   generating a third prompt at least by populating a third prompt template based at least on the one or more segments and the test specification, the third prompt corresponding to an implementation of the test specification;
   obtaining a test implementation that corresponds to testing satisfaction of the requirement by the software program based at least on a third output of the GLM that corresponds to the third prompt; and
performing a test of the software program based at least on the test implementation.

Example 19. The one or more processers of Example 18, wherein the operations further comprise generating additional test code based at least on a performance of the testing of the software program.

Example 20. The one or more processers of Example 19, wherein the additional test code is generated based at least on one or more additional GLM prompts that are based at least on the performance of the testing.

What is claimed is:

1. A method comprising:
generating one or more generative language model (GLM) prompts related to testing a software program, the one or more GLM prompts being based at least on one or more prompt templates that are populated based at least on program information that describes the software program and requirement information that describes a requirement of the software program;
generating testing architecture that corresponds to testing satisfaction of the requirement by the software program based at least on one or more outputs of the GLM that correspond to the one or more GLM prompts; and
testing the software program based at least on the testing architecture.

2. The method of claim 1, wherein:
the generating of the one or more GLM prompts includes generating a first prompt at least by populating a first prompt template based at least on the program information and the requirement information; and
the one or more outputs of the GLM include a first output that is based at least on the first prompt and that identifies one or more segments of the program information that correspond to the requirement.

3. The method of claim 2, wherein:
the generating of the one or more GLM prompts includes generating a second prompt at least by populating a second prompt template based at least on the requirement and the one or more segments; and
the one or more outputs of the GLM include a second output that is based at least on the second prompt and that identifies a test specification that corresponds to the requirement and that is included in the testing architecture.

4. The method of claim 3, wherein:
the generating of the one or more GLM prompts includes generating a third prompt at least by populating a third prompt template based at least on the one or more segments and the test specification; and
the one or more outputs of the GLM include a third output that is based at least on the third prompt and that identifies test code that corresponds to the testing architecture.

5. The method of claim 4, further comprising saving, as one or more entries in a repository, one or more of:
the first output of the GLM in association with the requirement information and the program information;
the second output of the GLM in association with the requirement information and the one or more segments; or
the third output of the GLM in association with the test specification.

6. The method of claim 1, further comprising evaluating performance of the testing of the software program.

7. The method of claim 6, wherein the evaluating of the performance of the testing includes determining a degree of code coverage corresponding to the testing.

8. The method of claim 6, further comprising generating additional test code based at least on the performance as evaluated.

9. The method of claim 7, wherein the additional test code is generated based at least on one or more additional GLM prompts that are based at least on the performance of the testing.

10. The method of claim 1, wherein the program information includes one or more of:
architecture documentation describing components of the software program and interactions between the components; or
interface specification documentation describing specific implementation details corresponding to the components.

11. A system comprising:
one or more processors to perform operations comprising:
generating a first prompt based at least on a first prompt template, program information that describes a software program, and requirement information that describes a requirement of the software program;
extracting one or more program information segments of the program information that relate to the requirement based at least on a first output of a generative language model (GLM) that is based at least on the first prompt;
generating a second prompt based at least on a second prompt template, the requirement information, and the one or more segments;
obtaining a test specification that corresponds to the requirement based at least on a second output of the GLM that is based at least on the second prompt;
generating a third prompt based at least on a third prompt template, the one or more segments, and the test specification;
obtaining a test implementation that corresponds to testing satisfaction of the requirement by the software program based at least on a third output of the GLM that is based at least on the third prompt; and
performing a test of the software program based at least on the test implementation.

12. The system of claim 11, further comprising saving, as one or more entries in a repository, one or more of:
the first output of the GLM in association with the requirement information and the program information;
the second output of the GLM in association with the requirement information and the one or more segments; or
the third output of the GLM in association with the test specification.

13. The system of claim 11, wherein the program information includes one or more of:
architecture documentation describing components of the software program and interactions between the components; or
interface specification documentation describing specific implementation details corresponding to the components.

14. The system of claim 11, wherein the operations further comprise generating additional test code based at least on a performance of the testing of the software program.

15. The system of claim 11, wherein the second template includes one or more example test specifications.

16. The system of claim 11, wherein the third template includes one or more example test implementations.

17. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.

18. One or more processors comprising:
processing circuitry to perform operations comprising:
generating a first prompt at least by populating a first prompt template based at least on program information that describes a software program and requirement information that describes a requirement of the software program, the first prompt corresponding to identifying portions of the program information that relate to the requirement;
extracting one or more segments of the program information that relate to the requirement based at least on a first output of a generative language model (GLM) that corresponds to the first prompt;
generating a second prompt at least by populating a second prompt template based at least on the requirement and the one or more segments, the second prompt corresponding to identification of behavior of the software program that is associated with satisfaction of the requirement;
obtaining a test specification that corresponds to the requirement based at least on a second output of the GLM that corresponds to the second prompt;
generating a third prompt at least by populating a third prompt template based at least on the one or more segments and the test specification, the third prompt corresponding to an implementation of the test specification;
obtaining a test implementation that corresponds to testing satisfaction of the requirement by the software program based at least on a third output of the GLM that corresponds to the third prompt; and
performing a test of the software program based at least on the test implementation.

19. The one or more processers of claim 18, wherein the operations further comprise generating additional test code based at least on a performance of the testing of the software program.

20. The one or more processers of claim 19, wherein the additional test code is generated based at least on one or more additional GLM prompts that are based at least on the performance of the testing.
